(19) United States
(12) Patent Application Publication
(10) Pub. No.: US 2025/0150816 A1
(43) Pub. Date: May 8, 2025

(54) VEHICULAR ACCESS POINT FOR AUTHENTICATING MEMBERS OF A VEHICULAR MICRO CLOUD

(71) Applicants: Toyota Jidosha Kabushiki Kaisha, Toyota-shi (JP); Toyota Motor Engineering & Manufacturing North America, Inc., Plano, TX (US)

(72) Inventors: Chunghan Lee, Mountain View, CA (US); Seyhan Ucar, Mountain View, CA (US); Onur Altintas, Mountain View, CA (US); Kentaro Oguchi, Mountain View, CA (US)

(21) Appl. No.: 18/387,778

(22) Filed: Nov. 7, 2023

(51) Int. Cl. H04W 12/0431; H04L 9/40; H04W 4/02; H04W 4/40; H04W 12/069; H04W 84/12; H04W 84/18; H04W 88/08

(52) U.S. Cl. CPC H04W 12/0431; H04L 63/065; H04W 4/02; H04W 4/40; H04W 12/069; H04W 84/12; H04W 84/18; H04W 88/08

(57) ABSTRACT

The disclosure includes embodiments for authenticating members of a vehicular micro cloud by a vehicular access point. A method executed by an edge server includes determining a group of remote vehicles having a similar heading and a similar schedule as an ego vehicle. The method includes determining that the ego vehicle is within a communication range of the group based on location data of the ego vehicle and the group. The method includes selecting the ego vehicle to serve as a vehicular access point for a vehicular micro cloud including the ego vehicle and the group as members. The method includes transmitting selected authentication keys to the ego vehicle wherein the selected authentication keys correspond to the group so that the ego vehicle authenticates the group based on the selected authentication keys.

### BACKGROUND

The specification relates to providing a vehicular access point for authenticating members of a vehicular micro cloud.

Modern vehicles broadcast vehicle-to-everything (V2X) messages that include digital data describing their locations, speeds, headings, past actions, and future actions, etc. Vehicles that broadcast V2X messages are referred to as “V2X transmitters.” Vehicles that receive the V2X messages are referred to as “V2X receivers.” The digital data that is included in the V2X messages can be used for various purposes including, for example, the proper operation of Advanced Driver Assistance Systems (ADAS systems) or autonomous driving systems which are included in the V2X receivers.

Modern vehicles include ADAS systems or automated driving systems. An automated driving system is a collection of ADAS systems which provides sufficient driver assistance that a vehicle is autonomous. ADAS systems and automated driving systems are referred to as “vehicle control systems.” Other types of vehicle control systems are possible. A vehicle control system includes code and routines, and optionally hardware, which are operable to control the operation of some or all of the systems of a vehicle.

### SUMMARY

Described herein are embodiments of a system, method, and a computer program product operable to provide key management and vehicular micro cloud-based authenticating services for members of a vehicular micro cloud.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method executed by a processor of an edge server. The method includes determining a group of remote vehicles having a similar heading data and a similar schedule as an ego vehicle; determining that the ego vehicle is within a communication range of the group based on location data of the ego vehicle and the group, selecting the ego vehicle to serve as a vehicular access point for a vehicular micro cloud including the ego vehicle and the group as members, and transmitting selected authentication keys to the ego vehicle where the selected authentication keys correspond to the group so that the ego vehicle authenticates the group based on the selected authentication keys. Other embodiments of this aspect include corresponding computer systems, apparatus, and computer programs recorded on one or more computer storage devices, each configured to perform the actions of the methods.

Implementations may include one or more of the following features. The method where a similar heading includes the ego vehicle and the group having headings that satisfy a threshold for similarity. A similar schedule includes the ego vehicle and the group having schedules that satisfy a threshold for similarity. Selecting the ego vehicle to serve as the vehicular access point for the vehicular micro cloud is based on the similar heading shared between the ego vehicle and the group. Selecting the ego vehicle to serve as the vehicular access point for the vehicular micro cloud is based on at least one of: the similar schedule shared between the ego vehicle and the group; the similar schedule shared between the ego vehicle and the group; and the determination that the ego vehicle is within the communication range of the group. Selecting the ego vehicle to serve as the vehicular access point for the vehicular micro cloud is based on each of: the similar schedule shared between the ego vehicle and the group; the similar schedule shared between the ego vehicle and the group; and the determination that the ego vehicle is within the communication range of the group. The ego vehicle is selected from a group that includes: a bus; a taxi; a parking enforcement vehicle; a refuse collection truck; and a government inspection vehicle. The ego vehicle is owned and operated by a government entity. A latency of the ego vehicle authenticating the group satisfies a threshold for latency. The method may include executing a certification process operable to ensure that the ego vehicle is trusted before transmitting the selected authentication keys to the ego vehicle. The method may include determining that a particular remote vehicle from the group is no longer within the communication range of the ego vehicle, determining a new ego vehicle closest to the particular remote vehicle, and sending an authentication key for the particular remote vehicle to the new ego vehicle. The method may include instructing the ego vehicle to delete the authentication key for the particular remote vehicle from the selected authentication keys stored by the ego vehicle so that only one vehicle stores the authentication key for the particular remote vehicle at any one time. Implementations of the described techniques may include hardware, a method or process, or computer software on a computer-accessible medium.

One general aspect includes a system of an edge server. The system also includes a non-transitory memory; and a processor communicatively coupled to the non-transitory memory, where the non-transitory memory stores computer readable code that is operable, when executed by the processor, to cause the processor to execute steps including: determining a group of remote vehicles having a similar heading and a similar schedule as an ego vehicle; determining that the ego vehicle is within a communication range of the group based on location data of the ego vehicle and the group; selecting the ego vehicle to serve as a vehicular access point for a vehicular micro cloud including the ego vehicle and the group as members; and transmitting selected authentication keys to the ego vehicle where the selected authentication keys correspond to the group so that the ego vehicle authenticates the group based on the selected authentication keys. Other embodiments of this aspect include corresponding computer systems, apparatus, and computer programs recorded on one or more computer storage devices, each configured to perform the actions of the methods.

Implementations may include one or more of the following features. The system where the non-transitory memory stores additional computer readable code that is operable, when executed by the processor, to cause the processor to execute additional steps including executing a certification process operable to ensure that the ego vehicle is trusted before transmitting the selected authentication keys to the ego vehicle. The non-transitory memory stores additional computer readable code that is operable, when executed by the processor, to cause the processor to execute additional steps including determining that a particular remote vehicle from the group is no longer within the communication range of the ego vehicle, determining a new ego vehicle closest to the particular remote vehicle, and sending an authentication key for the particular remote vehicle to the new ego vehicle. The non-transitory memory stores additional computer readable code that is operable, when executed by the processor, to cause the processor to execute additional steps including instructing the ego vehicle to delete the authentication key for the particular remote vehicle from the selected authentication keys stored by the ego vehicle so that only one vehicle stores the authentication key for the particular remote vehicle at any one time in addition to an edge server that also stores the authentication key for the particular remote vehicle at this one time. Implementations of the described techniques may include hardware, a method or process, or computer software on a computer-accessible medium.

One general aspect includes a computer program product including computer code stored on a non-transitory memory that is operable, when executed by a processor, to cause the processor to execute steps including determining a group of remote vehicles having a similar heading and a similar schedule as an ego vehicle, determining that the ego vehicle is within a communication range of the group based on location data of the ego vehicle and the group, selecting the ego vehicle to serve as a vehicular access point for a vehicular micro cloud including the ego vehicle and the group as members, and transmitting selected authentication keys to the ego vehicle where the selected authentication keys correspond to the group so that the ego vehicle authenticates the group based on the selected authentication keys. Other embodiments of this aspect include corresponding computer systems, apparatus, and computer programs recorded on one or more computer storage devices, each configured to perform the actions of the methods.

Implementations may include one or more of the following features. The computer program product where the non-transitory memory stores additional computer readable code that is operable, when executed by the processor, to cause the processor to execute additional steps including executing a certification process operable to ensure that the ego vehicle is trusted before transmitting the selected authentication keys to the ego vehicle. The non-transitory memory stores additional computer readable code that is operable, when executed by the processor, to cause the processor to execute additional steps including determining that a particular remote vehicle from the group is no longer within the communication range of the ego vehicle, determining a new ego vehicle closest to the particular remote vehicle, and sending an authentication key for the particular remote vehicle to the new ego vehicle. The non-transitory memory stores additional computer readable code that is operable, when executed by the processor, to cause the processor to execute additional steps including instructing the ego vehicle to delete the authentication key for the particular remote vehicle from the selected authentication keys stored by the ego vehicle so that only one vehicle stores the authentication key for the particular remote vehicle at any one time. Implementations of the described techniques may include hardware, a method or process, or computer software on a computer-accessible medium.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an operating environment for an assignment system according to some embodiments.

FIG. 2 is a block diagram illustrating an example computer system including a key manager according to some embodiments.

FIG. 3 is a block diagram illustrating an example computer system including the assignment system according to some embodiments.

FIG. 4 is a block diagram illustrating an example computer system including an authentication according to some embodiments.

FIG. 5 is a flowchart of an example method for assigning an ego vehicle to form a vehicular micro cloud and provide an authentication service according to some embodiments.

FIGS. 6A and 6B are a flowchart of an example method for assigning an ego vehicle to form a vehicular micro cloud and provide an authentication service according to some embodiments.

FIGS. 7A, 7B, and 7C are a flowchart of an example method for certifying a vehicle to serve as a vehicular access point according to some embodiments.

FIGS. 8A and 8B are a flowchart of an example method for providing an authentication service according to some embodiments.

FIG. 9 is a flowchart of an example method for joining a vehicular micro cloud to receive an authentication service according to some embodiments.

FIG. 10 is a flowchart of an example method for reassigning a particular remote vehicle to a second ego vehicle according to some embodiments.

### DETAILED DESCRIPTION

Described herein are embodiments of an assignment system. The functionality of the assignment system is now introduced according to some embodiments.

A vehicular micro cloud includes a group of connected vehicles that share their unused computing resources with one another via Vehicle-to-Vehicle (V2V) messages and/or Vehicle-to-Everything (V2X) messages to complete tasks that could not be completed by any one vehicle alone or whose completion would take too long to satisfy a threshold for timeliness or low latency. Vehicles included in the vehicular micro cloud are referred to as “members.” It is a requirement that all members of the vehicular micro cloud include an amount of unused computing resources that satisfies a threshold and that the members share all of their unused computing resources with the other members of the vehicular micro cloud as directed by a hub of the vehicular micro cloud.

The hub of the vehicular micro cloud is the leader of the vehicular micro cloud. The hub determines a vehicular micro cloud task to be completed. The hub determines how to break the vehicular micro cloud task down to sub-tasks. The hub determines which members of the vehicular micro cloud should complete which sub-tasks (alone or in combination with other members). The hub assigns the sub-tasks to the members via V2X communications. The hub actively manages the completion of the sub-tasks to ensure that all the sub-tasks are completed in a manner that satisfies a threshold for timeliness.

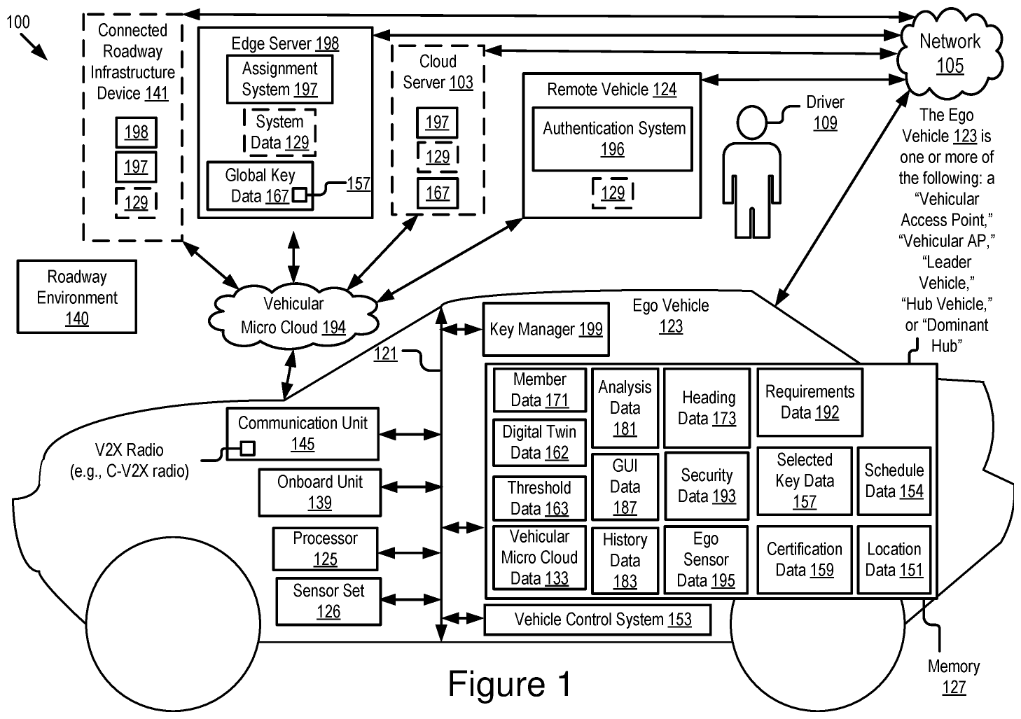

As described herein, the hub is also a vehicular access point (“vehicular AP” in FIG. 1). The term “vehicular access point” is now specially defined. The vehicular access point is a hub of a vehicular micro cloud. The vehicular access point includes a key manager (see, e.g., element 199 of FIG. 1) and provides the functionality of the key manager to remote vehicles that are in V2V communication range with the hub. The key manager is described in more detail below. The hub is always an ego vehicle, and so, the ego vehicle is also the vehicular access point for the vehicular micro cloud managed by the ego vehicle. The ego vehicle is a vehicle that is designated as the vehicle access point by a server to act as the vehicular access point for a group of remote vehicles having (1) a heading that satisfies first threshold for similarity relative to the ego vehicle and (2) a schedule that satisfies a second threshold for similarity relative to the ego vehicle. Accordingly, as specially defined herein, the vehicular access point is required to act as the hub for a group of remote vehicles having (1) a heading that satisfies first threshold for similarity relative to the ego vehicle that serves as the vehicular access point and (2) a schedule that satisfies a second threshold for similarity relative to the ego vehicle that serves as the vehicular access point. This group of vehicles are members of a vehicular micro cloud lead or managed by the vehicular access point. The vehicular access point is required to provide an authentication service for these members as part of the special definition for the term “vehicular access point.”

In some embodiments, the edge server requires that the ego vehicle pass a certification process to ensure that the ego vehicle is sufficiently trustworthy to act as the vehicular access point. This certification process is an optional element according to some embodiments.

As described herein, the ego vehicle is always the vehicular access point (or a candidate to become a vehicular access point) and the remote vehicles are always vehicles that join a vehicular micro cloud for the purpose of being authenticated. Accordingly, the vehicular micro cloud task for any vehicular micro cloud described herein is authenticating the remote vehicles that join the vehicular micro cloud as members of the vehicular micro cloud.

The term “vehicular micro cloud” is thus specially defined in this paragraph as well as other portions of this description. The vehicular micro cloud is a group of connected vehicles that share their unused computing resources with one another via V2V messages to execute a task. The task includes providing an authentication service. The ego vehicle is both the hub and vehicular access point of the vehicular micro cloud. The remote vehicles are those vehicles that join the vehicular micro cloud for the purpose of being authenticated by the vehicular micro cloud. The hub will not let any remote vehicle join the vehicular micro cloud unless the remote vehicle has an amount of unused computing resources that satisfy a threshold for membership and the remote vehicle shares these unused computing resources with the other members of the vehicular micro cloud as directed by the hub. The remote vehicles are required to have a similar heading and a similar schedule as the ego vehicle as a condition for joining the vehicular micro cloud as members. A similar heading is a heading of a remote vehicle that satisfies a threshold for similarity to the heading of the ego vehicle. A similar schedule is a schedule of a remote vehicle that satisfies a threshold for similarity to the schedule of the ego vehicle.

A “platoon” of vehicles and a “clique” of vehicles are expressly disclaimed from the special definition of “vehicular micro cloud.”

In some embodiments, the members of the vehicular micro cloud are required to have a same manufacturer (e.g., Toyota) or a selected manufacturer from a predetermined list of manufacturers (e.g., Toyota, Lexus, Scion, etc.).

A problem is that authenticating members of a vehicular micro cloud involves too much latency. A prior solution to authenticating members of a vehicular micro cloud involves a cloud server being used to authenticate the members. This approach is undesirable because the use of a cloud server imputes too much latency in the authentication process. For example, using a cloud server to authenticate members of the vehicular micro cloud has a latency of 0.5 to 5.0 seconds if using un-cached authentication keys and 1.0 to 6.0 seconds if using cached authentication keys. This is unworkable for real-world scenarios and often results in a time out error being issued by the cloud server instead of an actual authentication result. This approach is also undesirable because it is prone to attack from malicious users that steal the authentication keys when being transmitted back and forth between the hub and the cloud server.

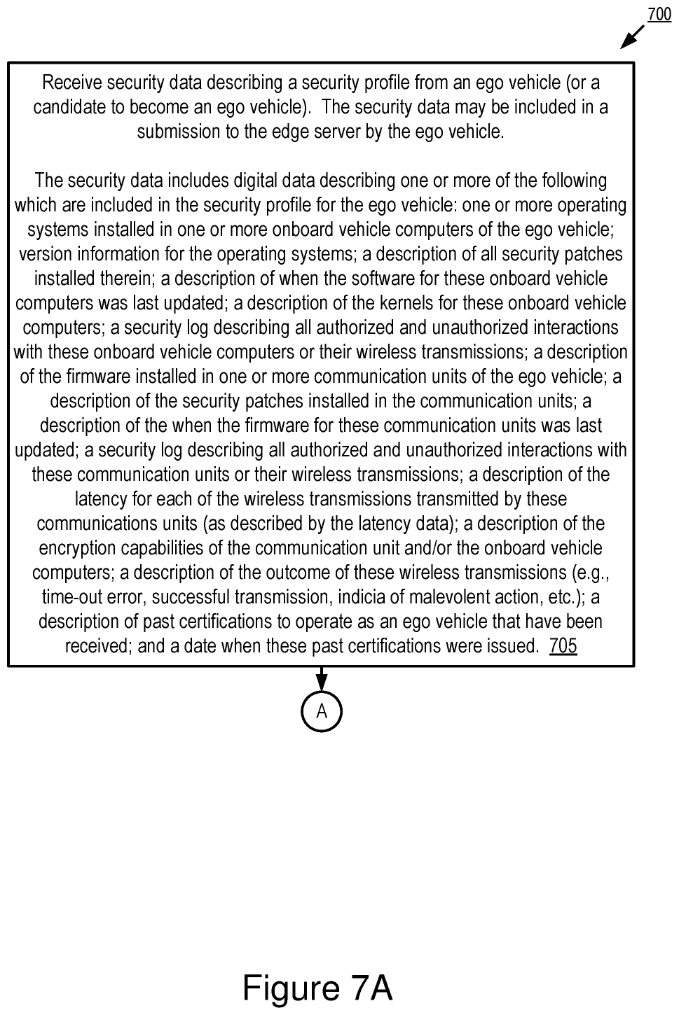

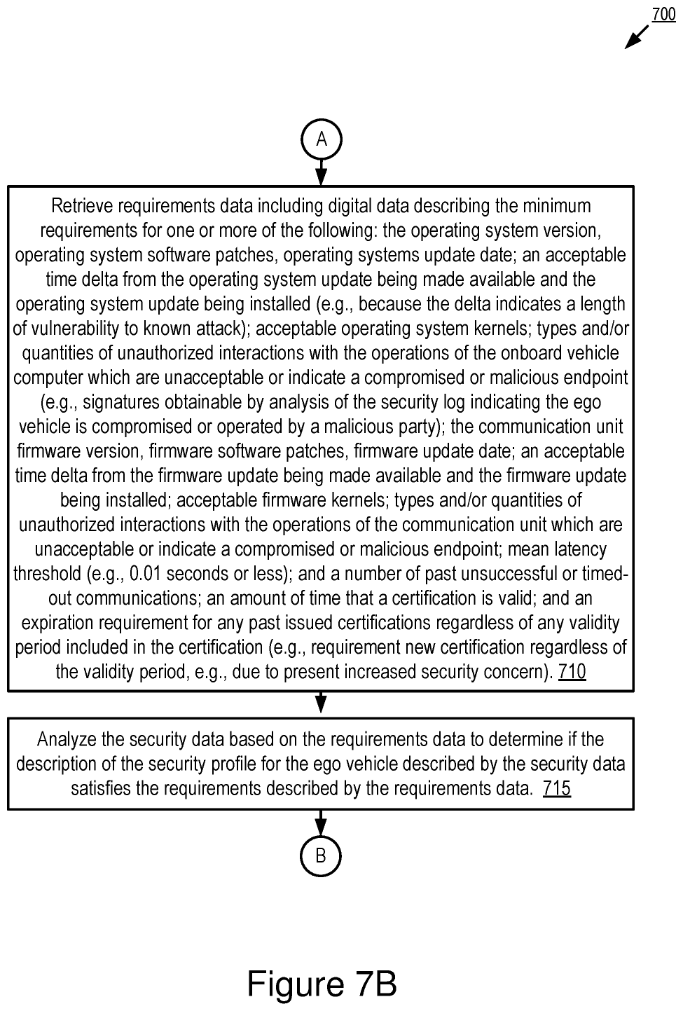

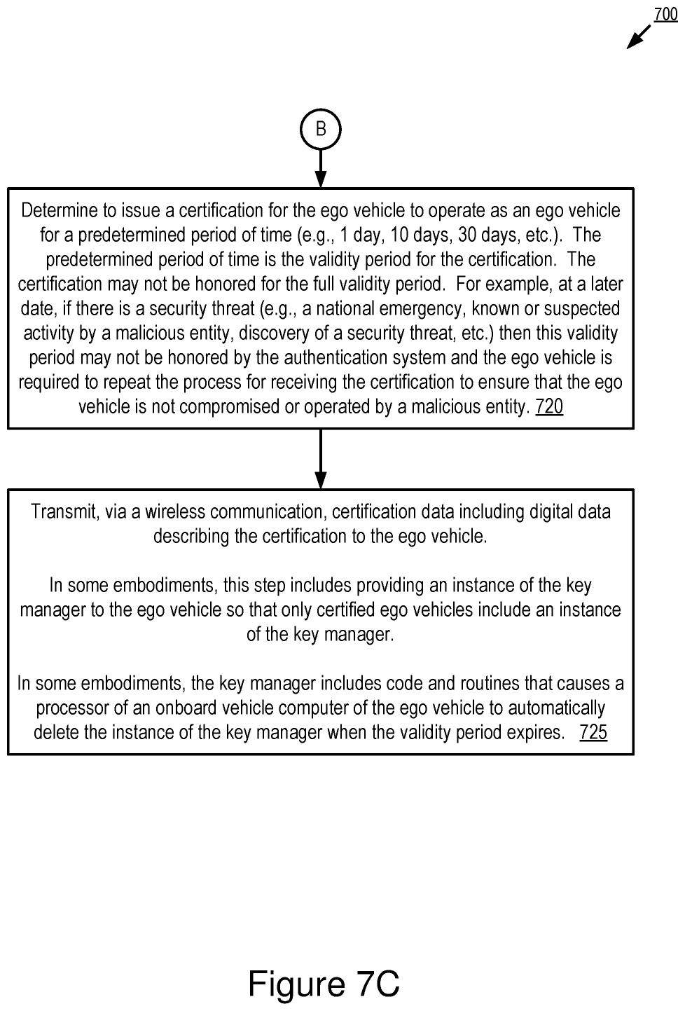

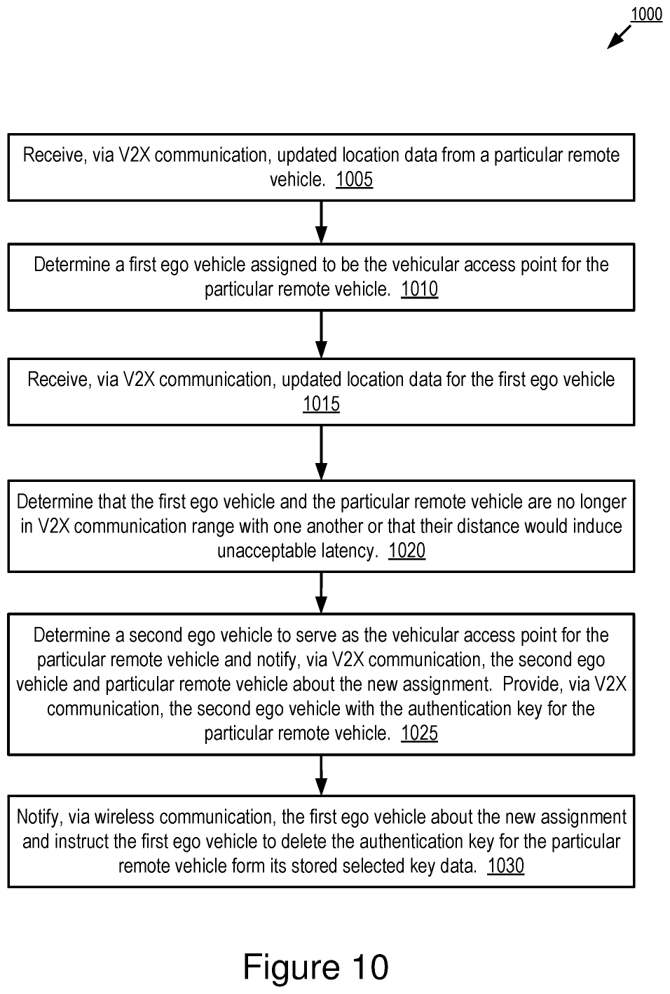

The embodiments described herein involve the use of a mobile endpoint (i.e., the ego vehicle) traveling on a roadway with a similar heading and schedule as the members that the ego vehicle is tasked with authenticating. As a result, the ego vehicle is in closer proximity to the members when compared to the first and second prior solutions, resulting in decreased latency. Our experiments show that the latency of the embodiments described herein is about 0.001 to 0.01 seconds if using un-cached authentication keys and 0.501 to 0.51 seconds if using cached authentication keys. This is a significant technical improvement over existing systems. Our research also shows that the execution of the embodiments described herein almost never results in time out errors being issued instead of authentication results, and so, authentication services do not fail due to time-out errors. This is another significant technical improvement relative to the existing solutions. These improvements are achievable because the authenticating entity (e.g., the ego vehicle) is a movable endpoint that is proximate to the remote vehicles that are being authenticated, and if one or more of the remote vehicles become non-proximate then these remote vehicles are reassigned to a new authenticating entity (see, e.g., FIG. 10), thereby providing a guarantee of near proximity and low latency between the authenticating entity and the remote vehicles. By comparison, existing solutions use static authenticating entities that are not guaranteed to be proximate to the remote vehicles. Moreover, some of the embodiments described herein include a certification process (see, e.g., FIGS. 7A, 7B, and 7C) that is implemented on a regular periodic or random basis to ensure that the ego vehicle remains a trusted provider of key management and vehicular micro cloud-based authentication services, and existing solutions do not include any similar certification.

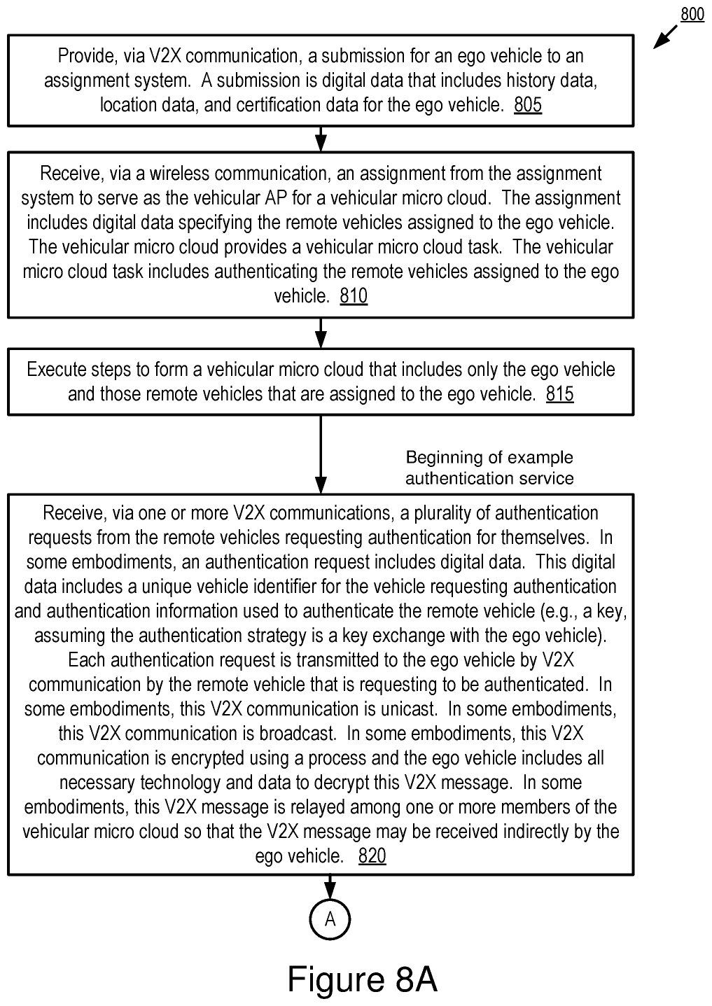

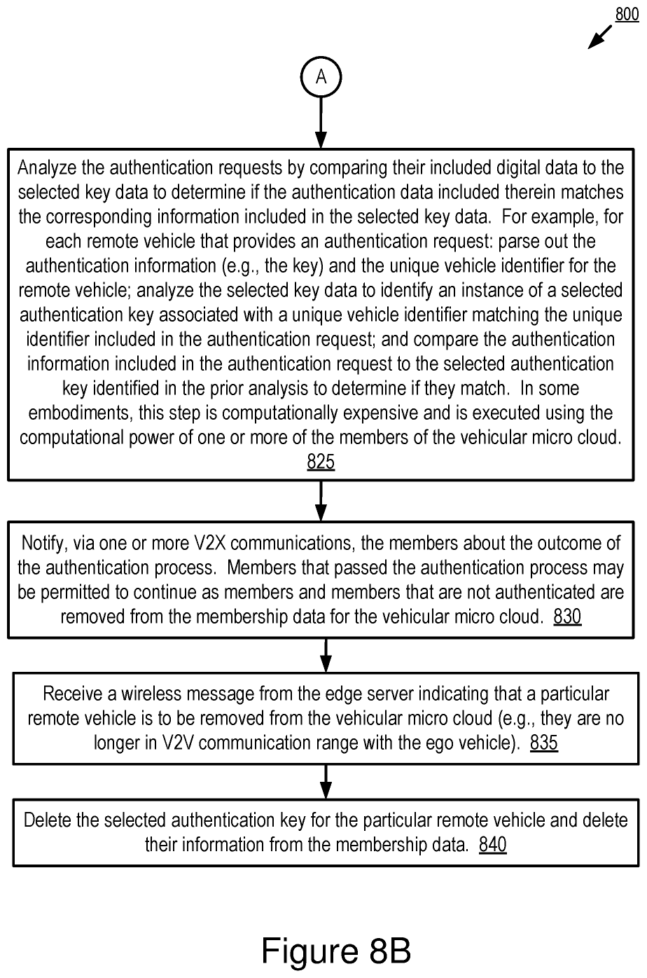

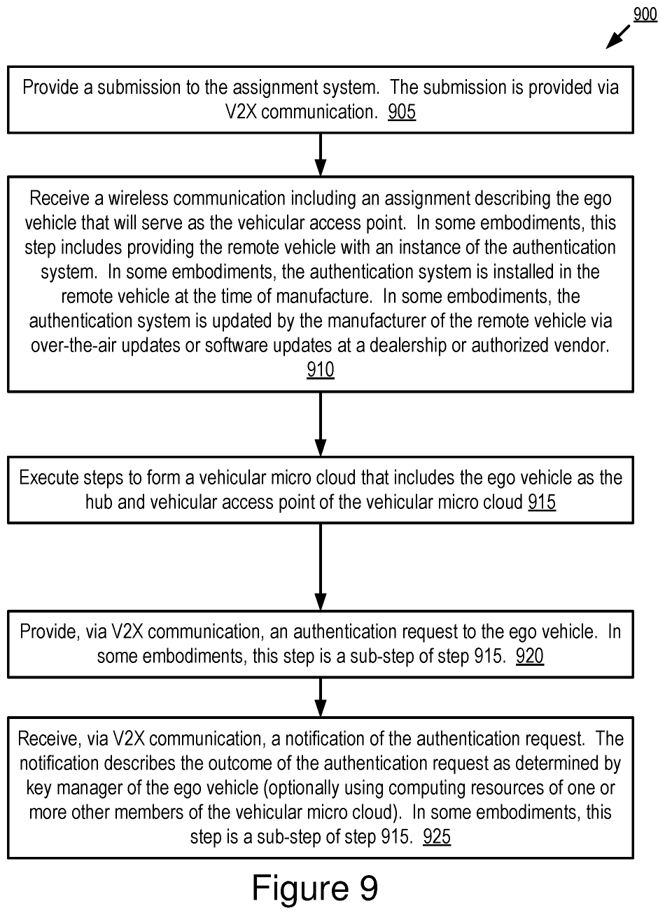

Vehicles include onboard sensors that constantly record sensor data describing sensor measurements of the onboard sensors. These sensor measurements describe the external environment of the vehicle. In some embodiments, the sensor data is time stamped so that individual sensor measurements recorded by the onboard sensors include a time stamp describing the time when the sensor measurement was recorded. Time data includes digital data that describes the time stamps for the sensor measurements that are described by the sensor data. Vehicles transmit V2X messages to one another. V2X messages include vehicular micro cloud data as the payload for the V2X messages. In some embodiments, the vehicular micro cloud data includes digital data that includes one or more of the sensor data and the time data. V2X messages include other types of data as well, including, for example instructions to form a vehicular micro cloud, instructions for steps to be executed, requests for additional data, authentication requests (see, e.g., FIGS. 8A and 9), notifications responsive to authentication requests (see, e.g., FIGS. 8B and 9) and any other data described herein or beneficial to execute the methods described herein.

The sensor data includes digital data describing the sensor measurements recorded by the onboard sensors (e.g., the sensor set). In some embodiments, instances of sensor data describe one or more sensor measurements, and the instances of sensor data are timestamped with time data to indicate the time when the one or more sensor measurements were recorded.

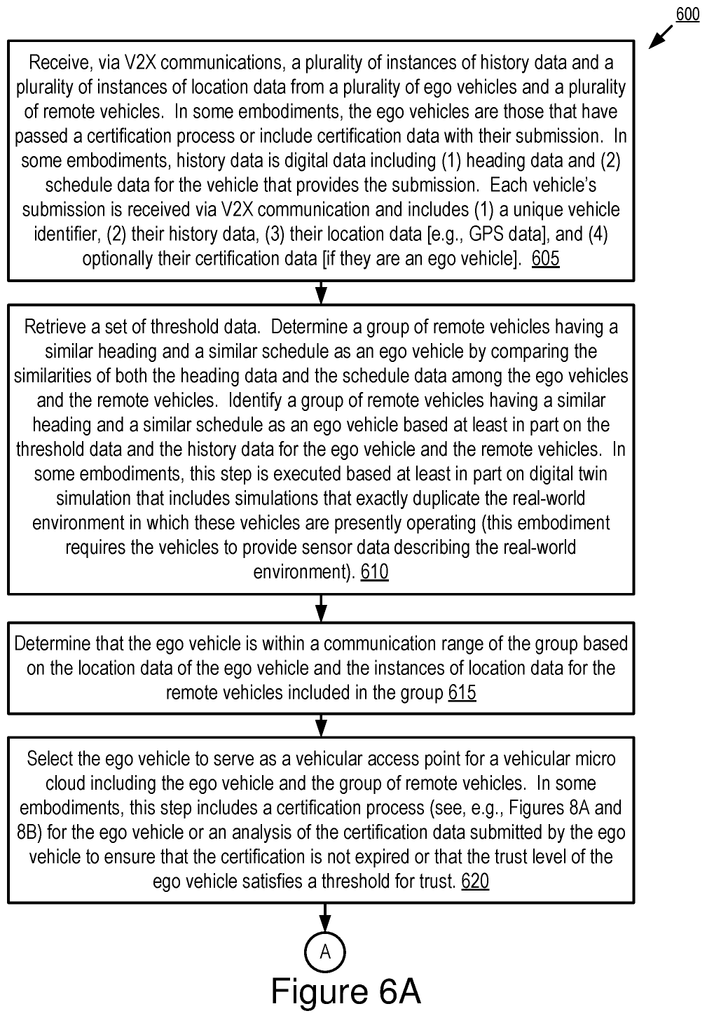

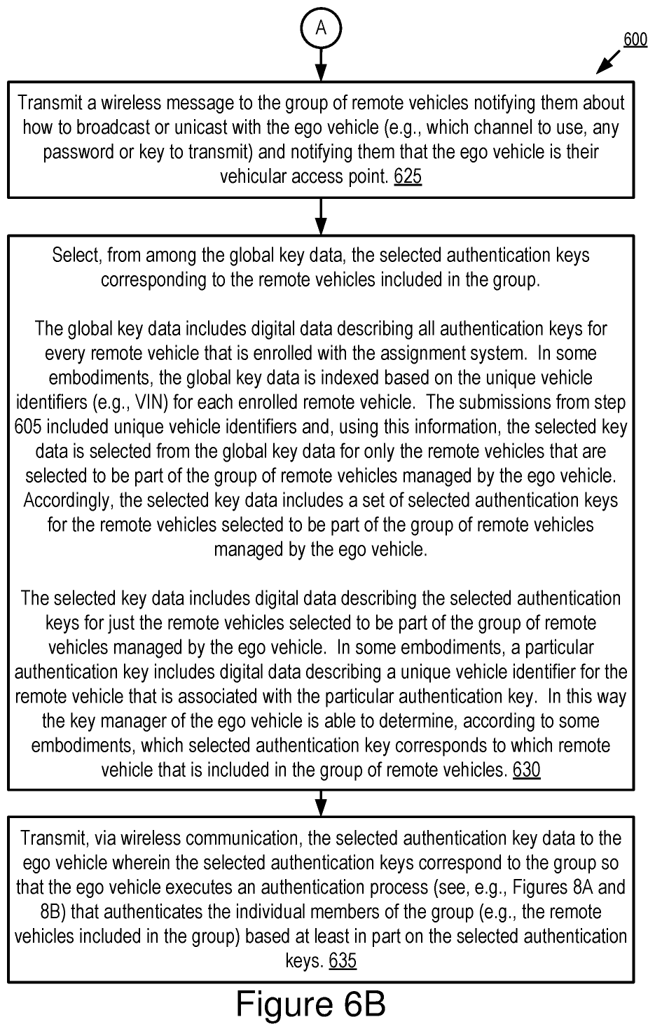

In some embodiments, this sensor data is used to generate a digital twin simulation (see, e.g., step 610 of FIG. 6A). Digital twin simulations are an optional feature of the embodiments described herein. Some embodiments do not include digital twin simulations.

A digital twin simulation is not the same thing as a “simulation” since a digital twin simulation exactly duplicates the real-world environment in which vehicles are presently operating. Accordingly, a digital twin simulation is specially defined as a computer-generated simulation that exactly duplicates the real-world environment in which an ego vehicle and two or more remote vehicles are presently operating.

In some embodiments, a vehicles such as an ego vehicle and a remote vehicle cause their onboard sensor sets to record sensor data describing sensor measurements of the roadway environment. Ego sensor data includes digital data that describes the sensor measurements recorded by the sensor set of an ego vehicle. An example of the ego sensor data in some embodiments includes the ego sensor data 195 depicted in FIG. 1. In some embodiments, the sensor measurements described by the ego sensor data 195 are time stamped. Time data includes digital data that describes the time stamps for the sensor measurements described by the ego sensor data 195.

Remote vehicles also include sensor sets similar to those included in the ego vehicle. Remote sensor data includes digital data that describes the sensor measurements recorded by the sensor set of a remote vehicle. An example of the remote sensor data in some embodiments includes remote sensor data. In some embodiments, the sensor measurements described by the remote sensor data are time stamped. Time data includes digital data that describes the time stamps for the sensor measurements described by the remote sensor data. In some embodiments, an ego vehicle 123 aggregates ego sensor data 195 and remote sensor data from one or more vehicles so that the digital twin simulation is more accurate than it would be if it were created using only the ego sensor data 195.

In some embodiments, remote sensor data is beneficial because it gives the assignment system a larger data set to rely upon, along with the ego sensor data 195, when generating digital twin simulations. In some embodiments, the remote sensor data is beneficial, for example, because it helps the assignment system have a better understanding of roadway environment of the ego vehicle (e.g., because the sensors of the remote vehicle are more accurate than those of the ego vehicle or have a different perspective relative to the sensors of the ego vehicle due to their different orientation or proximity relative to the sensors of the ego vehicle).

In some embodiments, the remote sensor data is transmitted to the ego vehicle via V2X messages. V2X messages include vehicular micro cloud data in their payload. Vehicular micro cloud data includes any digital data that is included in a payload of a V2X message. The terms “V2X message,” “V2X communication,” and “V2X transmission” refer to the same thing and can be used herein interchangeably. An example of the vehicular micro cloud data according to some embodiments includes the vehicular micro cloud data 133 depicted in FIG. 1. Any or all of the system data 129 may be included in the vehicular micro cloud data as the payload of a V2X message. In some embodiments, any digital data described herein may be included in the vehicular micro cloud data as some or all of the payload of a V2X message.

The vehicular micro cloud data includes, among other things, the sensor data such as the remote sensor data that vehicles record using their sensor sets. In some embodiments, vehicles that receive V2X messages use the vehicular micro cloud data included therein to improve their awareness of their environment. For vehicles that include vehicle control systems such as Advanced Driver Assistance Systems (ADAS systems) or autonomous driving systems, the vehicular micro cloud data is inputted to these systems so that they can better understand their driving environment when providing their functionality.

In some embodiments, a vehicular micro cloud includes an ego vehicle and a plurality of remote vehicles. The ego vehicle generates its own ego sensor data. The remote vehicles each generate their own remote sensor data. The members of the vehicular micro cloud transmit V2X messages to one another including vehicular micro cloud data including digital data describing their sensor measurements (e.g., one or more of the ego sensor data, the remote sensor data, and the time data). The key manager of an ego vehicle then relays all the sensor data to the assignment system of an edge server via V2X communications. In this way, the members of the vehicular micro cloud share their sensor measurements with one another so that other members (e.g., the ego vehicle) have access to the sensor measurements. In a similar manner, members share other data described herein with other members and/or with other vehicular micro clouds. Any digital data described herein can be shared in a similar fashion.

In some embodiments, the key manager includes code and routines that are operable, when executed by a processor, to cause the processor to manage cached authentication keys (e.g., selected key data) for the members of a vehicular micro cloud (e.g., remote vehicles assigned to the ego vehicle by the assignment system) and use these authentication keys to provide an authentication service for these members. After the authentication service is executed and completed the members of the vehicular micro cloud that passed the authentication service (e.g., those that were successfully authenticated by the authentication service) are able to send and receive V2X communications with the other members and provide service to these other members using the unused computational resources of the entire vehicular micro cloud.

In some embodiments, a vehicular micro cloud includes an ego vehicle and a plurality of remote vehicles. The ego vehicle generates its own ego sensor data. The remote vehicles each generate their own remote sensor data. The members of the vehicular micro cloud transmit V2X messages to one another including vehicular micro cloud data including digital data describing their sensor measurements (e.g., one or more of the ego sensor data, the remote sensor data, and the time data). In this way, the members of the vehicular micro cloud share their sensor measurements with one another.

An example of one specific type of sensor data includes location data. An example of the location data includes the location data 151 depicted in FIG. 1. In some embodiments, the location data includes GPS information. “GPS” refers to “geographic positioning system.” The location data includes digital data that describes the geographic location of an object such as the ego vehicle or a remote vehicle.

An example of the vehicular micro cloud data according to some embodiments includes the vehicular micro cloud data 133 depicted in FIG. 1. For example, with reference to FIG. 1, the remote sensor data is received by the communication unit of the ego vehicle via a V2X transmission that includes vehicular micro cloud data including the remote sensor data as its payload; the key manager of the ego vehicle then parses the remote sensor data from the vehicular micro cloud data and stores the vehicular micro cloud data and the remote sensor data in the memory 127 of the ego vehicle 123. In some embodiments, the remote sensor data includes the location data 151 for a remote vehicle which is an example of the remote sensor data. Other types of remote sensor data are possible.

In some embodiments, the vehicular micro cloud data includes the member data for the vehicular micro cloud. In this way, members of a vehicular micro cloud share sensor data and member data with one another. The member data describes, among other things, which tasks are assigned to which member of the vehicular micro cloud. The member data is described in more detail below.

A cloud server includes a conventional hardware server having network communication capabilities such as a computer, a laptop, a microcomputer, etc. An example of a cloud server according to some embodiments includes a cloud server 103 as depicted in FIG. 1. An edge server includes a conventional hardware server having network communication capabilities such as a computer, a laptop, a microcomputer, etc. An example of an edge server according to some embodiments includes an edge server 198 as depicted in FIG. 1. A cloud server includes a conventional hardware server having network communication capabilities such as a computer, a laptop, a microcomputer, etc. An example of an edge server according to some embodiments includes a cloud server 103 as depicted in FIG. 1.

In some embodiments, an edge server is an element of a roadside unit (RSU) that is located within a roadway environment. By contrast, a cloud server is generally not located within a roadway environment. An example of an RSU according to some embodiments includes the connected roadway infrastructure device 141 depicted in FIG. 1. A connected roadway infrastructure device 141 includes, for example, an RSU having a processor and a communication unit such as those described below as elements of the ego vehicle 123.

### Vehicular Micro Clouds

As described above, the term “vehicular micro cloud” has a special definition. A vehicular micro cloud includes an ego vehicle and a group of remote vehicles. The ego vehicle is the hub of the vehicular micro cloud. The ego vehicle is also the vehicular access point for the vehicular micro cloud.

The ego vehicle is a connected vehicle that includes an instance of the key manager. An example of the key manager according to some embodiments includes the key manager 199 depicted in FIG. 1. A remote vehicle is a connected vehicle that includes an instance of the authentication system. An example of the authentication system according to some embodiments includes the authentication system 196 depicted in FIG. 1.

A vehicle that does not include an instance of the key manager is not an ego vehicle. In some embodiments, the key manager includes code and routines that are operable, when executed by a processor, to cause the processor to execute one or more steps of the method 800 depicted in FIG. 8. The key manager is described in more detail below.

A vehicle that does not include an instance of the authentication system is not a remote vehicle. In some embodiments, the key manager includes code and routines that are operable, when executed by a processor, to cause the processor to execute one or more steps of the method 900 depicted in FIG. 9. The authentication system is described in more detail below.

A connected vehicle is a vehicle including a communication unit having access to a network that is usable to send and receive wireless messages. An example of the communication unit includes the communication unit 145 depicted in FIG. 1. An example of the network includes the network 105 depicted in FIG. 1. The communication unit 145 and the network 105 are described in more detail below.

A vehicular access point is an ego vehicle that is certified to receive protected information from an assignment system. An example of the certification process according to some embodiments includes the method 700 depicted in FIGS. 7A, 7B, and 7C. An example of the protected information includes a set of authentication keys for a group of remote vehicles that are assigned to be managed by the ego vehicle during the formation of a vehicular micro cloud that is formed for the purpose of providing an authentication service to the remote vehicles. For example, the protected information includes the selected key data. The selected key data is described in more detail below.

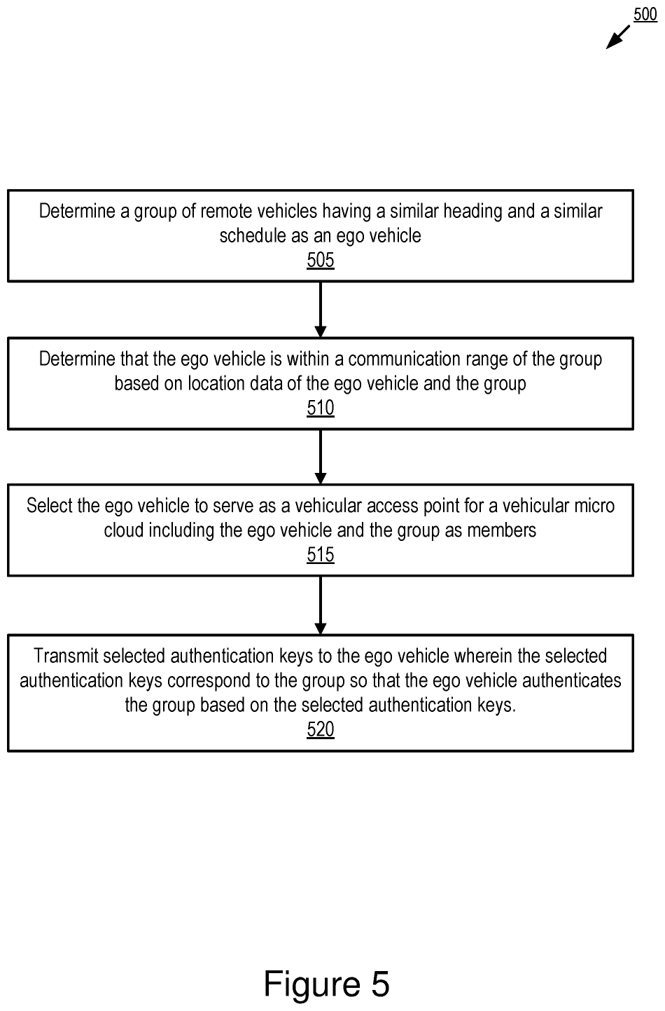

An edge server includes an instance of an assignment system. The assignment system includes code and routines that are operable, when executed by a processor of the edge server, to cause the processor to execute a process to determine which ego vehicle should be grouped with which remote vehicles for the for the purpose of forming a vehicular micro cloud whose purpose is providing an authentication service to the remote vehicles. An example of this process includes the method 500 depicted in FIG. 5 and the method 600 depicted in FIGS. 6A and 6B.

In some embodiments, the assignment system includes code and routines that are operable, when executed by a processor, to cause the processor to execute one or more steps of method 500 depicted in FIG. 5, method 600 depicted in FIGS. 6A and 6B, method 700 depicted in FIGS. 7A, 7B, and 7C and method 1000 depicted in FIG. 10. The assignment system is described in more detail below.

The assignment system groups ego vehicles and remote vehicles together based on the similarities of their: (1) heading data; (2) schedule data; and (3) location data. An example of how this grouping is done according to some embodiments is described in the method 500 depicted in FIG. 5 and the method 600 depicted in FIG. 6.

For example, a plurality of candidate ego vehicles and plurality of candidate remote vehicles transmit V2X communications to the edge server including their heading data, schedule data, and location data. The assignment system analyzes this digital data and determines an ego vehicle and a group of remote vehicles that have similar locations, headings, and schedules based on the data they transmitted to the edge server. The assignment system then transmits V2X communications to the ego vehicle and the group of remote vehicles including digital data that describes their assignment to form a vehicular micro cloud for the purpose of authenticating the group of remote vehicles. The ego vehicle is assigned to serve as the hub and vehicular access point for the vehicular micro cloud. The remote vehicles are assigned to provide their unused computing resources to the other members of the vehicular micro cloud for the purpose of providing the authentication service to the members of the vehicular micro cloud.

History data is digital data that includes the heading data and the schedule data for a particular candidate vehicle (e.g., candidate ego vehicle or candidate remote vehicle) that provides the history data to the edge server. A candidate ego vehicle is a vehicle that provides their history data and location data to the edge server. Once assigned to serve as the hub and vehicular access point for a vehicular micro cloud, the candidate ego vehicle is referred to as an “ego vehicle.” A candidate remote vehicle is a vehicle that provides their history data and location data to the edge server. Once assigned to serve as a remote vehicle within a vehicular micro cloud, the candidate remote vehicle is referred to as a “remote vehicle.” An example of the history data according to some embodiments includes the history data 183 depicted in FIG. 1.

Heading data includes digital data that describes a heading for the entity (e.g., ego vehicle, candidate ego vehicle, remote vehicle, candidate remote vehicle) that transmits the V2X message including the heading data within its payload to the edge server. For example, the heading data includes digital data that describes the heading for an ego vehicle or a candidate ego vehicle that transmits the V2X message including the heading data within its payload to the edge server. As another example, the heading data includes digital data that describes heading for a remote vehicle or a candidate remote vehicle that transmits the V2X message including the heading data within its payload to the edge server. An example of the heading data according to some embodiments includes the heading data 173 depicted in FIG. 1.

Schedule data includes digital data that describes a schedule for the entity that transmits the V2X message including the schedule data within its payload to the edge server. A schedule includes digital data that describes a planned route for the entity. In some embodiments, the planned route includes a starting point and a time when the entity left that starting point. In some embodiments, the planned route includes one or more destinations (or intermediate destinations) and the times when the entity plans or expects to be at those one or more destinations (or intermediate destinations). An intermediate destination is a stop between the starting point and the ultimate destination for a planned route.

Examples of the schedule data are now provided. In one example, the schedule data includes digital data that describes the schedule for an ego vehicle or a candidate ego vehicle that transmits the V2X message including the heading data within its payload to the edge server. As another example, the schedule data includes digital data that describes schedule for a remote vehicle or a candidate remote vehicle that transmits the V2X message including the heading data within its payload to the edge server. An example of the schedule data according to some embodiments includes the schedule data 154 depicted in FIG. 1.

In some embodiments, the ego vehicle includes a car, bus, van, truck, garbage collection truck, recycling collection truck, train, streetcar, shuttle, or some other conveyance having a fixed schedule. For example, the ego vehicle includes a garbage collection truck having a fixed schedule. In some embodiments, the ego vehicle is operated by a governmental agency since the operators of these vehicles are trustworthy to handle protected information such as the selected key data. In some embodiments, the ego vehicle is a police cruiser that travels a predetermined route according to a fixed schedule (e.g., their patrol route).

As described above, a vehicular micro cloud includes a group of connected vehicles that perform an authentication service cooperatively or collaboratively. As described herein, the vehicular micro cloud provides an authentication service for one or more remote vehicles. For example, the ego vehicle, acting as the hub and the vehicular access point, authenticates the remote vehicles that are assigned to the vehicular micro cloud managed by the ego vehicle by the assignment system of an edge server.

Vehicular micro clouds can be divided into two categories based on their mobility: (1) stationary; and (2) mobile.

In the stationary cloud, a certain geographical region is designated as the vehicular micro cloud region, and vehicles entering that region contribute their resources for vehicular cloud services. A stationary vehicular micro cloud is sometimes referred to as a “static” vehicular micro cloud.

In a mobile vehicular micro cloud the geographic region of the vehicular micro cloud changes over time because the hub of the vehicular micro cloud is moving. The vehicular micro cloud included in the embodiments described is a mobile vehicular micro cloud since the ego vehicle is traveling consistent with its heading and schedule as described by the heading data and schedule data it provides to the edge server.

In some embodiments, the key manager causes the vehicles to execute steps to form the vehicular micro cloud. The key manager of the ego vehicle and the authentication systems of the remote vehicles collaborate through V2X messages to execute steps to form the vehicular micro cloud.

In some embodiments, the key manager initiates the formation of the vehicular micro cloud by transmitting a V2X message including digital data that triggers the formation of the vehicular micro cloud. The authentication systems of the remote vehicles take steps to provide digital data to the key manager that enables the formation of the vehicular micro cloud. The digital data provided by the authentication systems becomes part of the member data for the vehicular micro cloud. The digital data provided by an authentication system for any particular remote vehicle describes the components of the member data that describe this particular remote vehicle. For example, the digital data for a particular remote vehicle describes a unique vehicle identifier for the remote vehicle and the specific unused computing resources which this vehicle has available to share with the other members of the vehicular micro cloud.

Member data includes digital data that describes information about a vehicular micro cloud and its members. For example, the member data is digital data that describes the identity of the members of the vehicular micro cloud and their specific computing resources; all members of the vehicular micro cloud make their computing resources available to one another for their collective benefit. An example of the member data according to some embodiments includes the member data 171 depicted in FIG. 1.

In some embodiments, the key manager causes the communication unit of the ego vehicle to transmit a wireless message to each remote vehicle assigned to the ego vehicle by the assignment system that causes these remote vehicles to provide their contributions to the member data via one or more V2X communications and join the vehicular micro cloud. In some embodiments, these V2X communications also include sensor data recorded by the vehicles that transmit the V2X communications.

The remote vehicle is required to share all of its unused computing resources with the other members of the vehicular micro cloud. In some embodiments, the unused computing resources shared with the other members must be sufficient to satisfy a threshold amount or type specified by the key manager.

In some embodiments, when a new vehicle joins the vehicular micro cloud managed by the hub, the hub generates new member data for the vehicular micro cloud including, among other things, digital data describing the schedule of tasks which includes those tasks assigned to the new member. The hub then transmits V2X messages to the members of the vehicular micro cloud that includes vehicular micro cloud data that distributes the new member data to the members of the vehicular micro cloud, including the new member. The authentication system for the new member is now responsible for executing the tasks assigned to it by the hub as described in the member data.

As briefly introduced above, vehicular micro clouds provide vehicular micro cloud tasks. A vehicular micro cloud task includes any task executed by a vehicular micro cloud or a group of vehicular micro clouds. As used herein, the terms “task” and “vehicular micro cloud task” refer to the same thing. A “sub-task” as used herein is a portion of a task or vehicular micro cloud task.

As described herein, the task provided by the vehicular micro cloud includes executing a computing process that is an element of delivering an authentication service to one or more members of the vehicular micro cloud. An example of the authentication service according to some embodiments is described in the method 800 depicted in FIGS. 8A and 8B.

In some embodiments, the member data describes, for each member of a particular vehicular micro cloud, the tasks assigned to each member. The member data also describes a schedule of tasks for the vehicular micro cloud. A schedule of tasks described by the member data 171 includes, for one or more vehicular micro clouds, digital data that describes one or more of the following: (1) what tasks are assigned; (2) for each assigned task, which member it is assigned to; and (3) for each assigned task, time(s) when the task is to be started and/or completed. In some embodiments, the members of a vehicular micro cloud exchange V2X messages and the vehicular micro cloud data includes, among other types of digital data, the member data.

In some embodiments, the vehicular micro cloud assigned by the hub of a vehicular micro cloud includes some or all of the tasks which are necessary to provide the authentication service. In some embodiments, the key manager is operable to dynamically change and reorganize a schedule of tasks for the members whenever a member enters or leaves the vehicular micro cloud to ensure that the authentication service provided by the vehicular micro cloud is uninterrupted even as members are entering and leaving the vehicular micro cloud.

In some embodiments, the authentication service provided by the vehicular micro cloud is a task which would not be providable by any one vehicle alone with a low enough latency to satisfy a threshold for latency.

The vehicular micro cloud includes multiple members. In some embodiments, a member of the vehicular micro cloud includes a remote vehicle that (1) is assigned to the vehicular micro cloud by the assignment system, (2) shares its unused computing resources with the other members of the vehicular micro cloud, and (3) sends and receives V2X messages via a network (e.g., the network 105 depicted in FIG. 1).

In some embodiments, the authentication service provided by the vehicular micro cloud is collaboratively performed by the plurality of members executing computing processes in parallel which are configured to complete the provision of the authentication service. In some embodiments, a vehicular micro cloud includes a plurality of members that execute computing processes whose completion results in the execution of the authentication service.

Vehicular micro clouds are beneficial, for example, because they help vehicles to perform computationally expensive tasks (e.g., the authentication service) that they could not perform alone. For example, in some embodiments a first problem is that the authentication service described herein is too computationally expensive to be completed by any one vehicle alone. In some embodiments, a second problem is that the authentication service described herein is so computationally expensive that its completion by any one vehicle would take too long to satisfy a threshold for timeliness or low latency. The vehicular micro cloud provided by the key manager and made possible by the beneficial operation of the assignment system solves both of these problems by enabling members of the vehicular micro cloud to share their unused computational resources with other members of the vehicular micro cloud.

Vehicular micro clouds are described in the patent applications that are incorporated by reference in this paragraph. This patent application is related to the following patent applications, the entirety of each of which is incorporated herein by reference: U.S. patent application Ser. No. 16/943,443 filed on Jul. 30, 2020 and entitled “Vehicular Nano Cloud”; U.S. Pat. No. 10,924,337 issued on Feb. 16, 2021 and entitled “Vehicular Cloud Slicing”; U.S. patent application Ser. No. 15/358,567 filed on Nov. 22, 2016 and entitled “Storage Service for Mobile Nodes in a Roadway Area”; U.S. patent application Ser. No. 15/799,442 filed on Oct. 31, 2017 and entitled “Service Discovery and Provisioning for a Macro-Vehicular Cloud”; U.S. patent application Ser. No. 15/845,945 filed on Dec. 18, 2017 and entitled “Managed Selection of a Geographical Location for a Micro-Vehicular Cloud”; U.S. patent application Ser. No. 15/799,963 filed on Oct. 31, 2017 and entitled “Identifying a Geographic Location for a Stationary Micro-Vehicular Cloud”; U.S. patent application Ser. No. 16/443,087 filed on Jun. 17, 2019 and entitled “Cooperative Parking Space Search by a Vehicular Micro Cloud”; U.S. patent application Ser. No. 16/739,949 filed on Jan. 10, 2020 and entitled “Vehicular Micro Clouds for On-demand Vehicle Queue Analysis”; U.S. patent application Ser. No. 16/735,612 filed on Jan. 6, 2020 and entitled “Vehicular Micro Cloud Hubs”; U.S. patent application Ser. No. 16/387,518 filed on Apr. 17, 2019 and entitled “Reorganizing Autonomous Entities for Improved Vehicular Micro Cloud Operation”; U.S. patent application Ser. No. 16/273,134 filed on Feb. 11, 2019 and entitled “Anomaly Mapping by Vehicular Micro Clouds”; U.S. patent application Ser. No. 16/246,334 filed on Jan. 11, 2019 and entitled “On-demand Formation of Stationary Vehicular Micro Clouds”; and U.S. patent application Ser. No. 16/200,578 filed on Nov. 26, 2018 and entitled “Mobility-oriented Data Replication in a Vehicular Micro Cloud.” These patent applications describe vehicular micro clouds that do not fit the precise special definition of the term “vehicular micro cloud” as described herein, and so, incorporating these patent applications herein by reference is not to be interpreted as modifying the special definition of the term “vehicular micro cloud” which has been described in the preceding paragraphs.

In some embodiments, the authentication system of each remote vehicle of the vehicular micro cloud is operable to execute operations that are operable to complete a set of tasks assigned by the key manager of the ego vehicle.

The endpoints that are part of the vehicular micro cloud may be referred to herein as “members,” “micro cloud members,” or “member vehicles.” The members include the ego vehicle and the remote vehicles assigned to the ego vehicle by the assignment system of the edge server. In some embodiments, the members complete a handshake process in order to form the vehicular micro cloud.

As used herein, the term “sensor data” refers to one or more of the ego sensor data, the remote sensor data, or a combination of the ego data and the remote sensor data.

The driver 109 is a human driver of the ego vehicle 123. In some embodiments, a remote vehicle 124 also includes a driver that is not depicted.

In some embodiments, the vehicular micro cloud data 133 is received by the ego vehicle 123 because the ego vehicle 123 and the remote vehicle 124 are members of the same vehicular micro cloud 194.

Threshold data includes digital data that describes any threshold described herein. An example of the threshold data includes the threshold data 163 depicted in FIG. 1.

In some embodiments, the threshold data describes a threshold that is determined by the assignment system to be a minimum number of stops that an ego vehicle and a particular remote vehicle have to have in common in their schedule data in order for the ego vehicle and the remote vehicle to be assigned to the same vehicular micro cloud (i.e., for their schedule to be determined by the assignment system to be similar as described in step 610 of FIG. 6A). In some embodiments, the stops of the schedule do not have to be exactly the same but on the same driving route as one another so that the ego vehicle and the remote vehicle are heading in the same general direction and using the same roads in their travel plans.

In some embodiments, the threshold data describes a threshold that is determined by the assignment system to be a minimum degree distance that can separate the heading of the ego vehicle and the heading of a particular remote vehicle in their heading data in order for the ego vehicle and the remote vehicle to be assigned to the same vehicular micro cloud (i.e., for their headings to be determined by the assignment system to be similar as described in step 610 of FIG. 6A).

In some embodiments, an ego vehicle and the remote vehicle can have the same heading even though their present headings are presently different. For example, if the road they are traveling on has a curve in it then the ego vehicle and the remote vehicle may have different headings depending on where they are located within the curve of the roadway. However, if they are traveling in the same direction on the same road then they are determined to have a similar heading.

In some embodiments, the heading of a particular vehicle (e.g., an ego vehicle or a remote vehicle) is the heading of that vehicle as measured by a compass. The heading can be measured in by the degrees of the compass. In some embodiments, heading is based on cardinal directions, so 0° (or 360°) indicates a direction toward true north, 900 true east, 1800 true south, and 2700 true west. The heading of a particular vehicle is the compass direction in which the vehicle's front bumper is pointed. In some embodiments, the heading of a particular vehicle may not necessarily be the direction that the vehicle actually travels, which is known as its route, course, or track. Any difference between the heading and route is due to the motion of the underlying medium (e.g., the road surface or liquids or solids overlaying the road surface) or other effects like skidding or slipping.

In some embodiments, the threshold data describes a maximum distance that can separate the location of the ego vehicle and the location of a particular remote vehicle in their location data in order for the ego vehicle and the remote vehicle to be assigned to the same vehicular micro cloud (i.e., for their locations to be determined by the assignment system to be similar in step 610 of FIG. 6A). For example, the assignment system determines that a threshold for the location data is the maximum communication range of the V2X communication being used by the ego vehicle when forming the vehicular micro cloud. In some embodiments, this maximum communication range is within 1 to 1500 meters.

Analysis data includes digital data that describes the output or process of any analysis executed by one or more of the assignment system 197, the key manager 199, and the authentication system 196. For example, the analysis data describes any output executed following the execution of any method described herein (e.g., methods 500, 600, 700, 800, 900, and 1000 depicted in FIGS. 6A-6B, 7A-7C, 8A-8B, 9, and 10, respectively). In some embodiments, the analysis data includes digital data that identifies one or more similarities as described in step 610 of FIG. 6A. In some embodiments, the analysis data includes digital data that describes an ego vehicle and a group of remote vehicles that should be assigned to form a vehicular micro cloud. An example of the analysis data according to some embodiments includes the analysis data 181 depicted in FIG. 1.

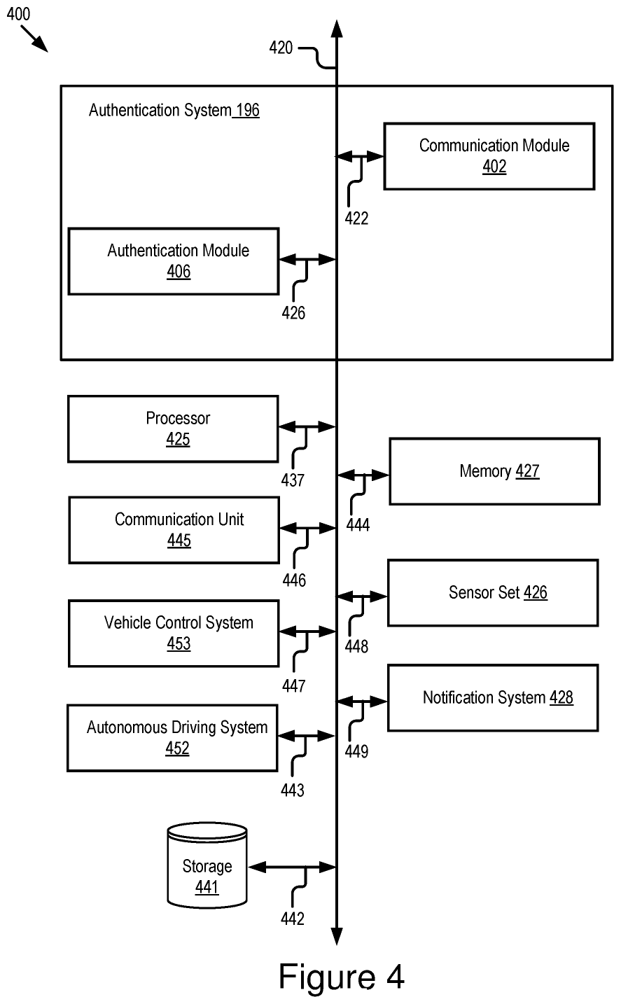

In some embodiments, a vehicle includes a notification system. A notification system includes one or more electronic devices that are operable to provide a notification to a driver of a remote vehicle that notifies them about the status of their authentication. For example, the notification describes whether the remote vehicle passed or failed the authentication service. An example of a notification includes one or more of the following: a graphical user interface (GUI); a visual display; an audible sound; one or more lights, or some other human discernable stimulation that provides information to a driver of a remote vehicle. An example of the notification system according to some embodiments includes the notification system 428 depicted in FIG. 4.

According to some embodiments, the notification system includes one or more of the following: an electronic display; a speaker; a heads-up display unit; an infotainment system; a vibration device; a light emitting device; etc. In some embodiments, the notification system is operable to receive vehicular micro cloud data describing the authentication result of an authentication service and provide a notification to the driver of the vehicle describing this information.

GUI data includes digital data that describes a GUI. For example, a GUI that describes a GUI that is generated and displayed by the notification system. An example of the GUI data according to some embodiments includes the GUI data 187 depicted in FIG. 1.

In some embodiments, the electronic display device is embedded in a surface of the remote vehicle such as a rear-view mirror, a side mirror, a windshield, etc.

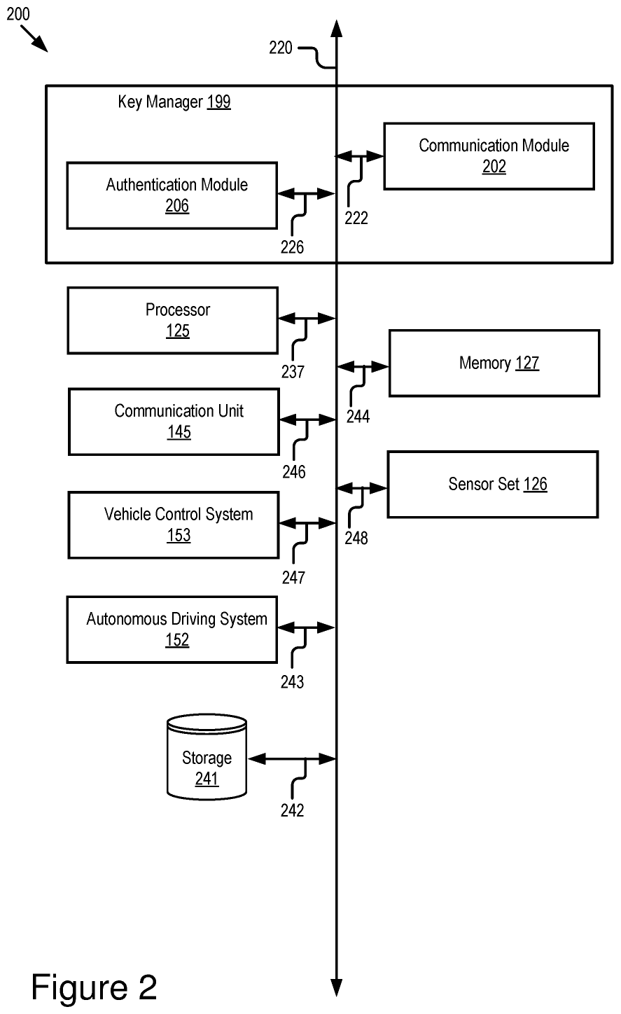

A vehicle control system is an onboard system of a vehicle that controls the operation of a functionality of the vehicle. ADAS systems and autonomous driving systems are examples of vehicle control systems. Examples of the vehicle control system according to some embodiments includes the vehicle control system 153 depicted in FIGS. 1 and 2 and the autonomous driving system 152 depicted in FIG. 2 and the autonomous driving system 452 depicted in FIG. 4.

In some embodiments, the assignment system includes code and routines that are operable, when executed by a processor, to cause the processor to execute one or more steps of the method 500 depicted in FIG. 5, the method 600 depicted in FIGS. 6A and 6B, the method 700 depicted in FIGS. 7A, 7B, and 7C, and the method 1000 depicted in FIG. 10. The assignment system may be an element of one or more of the following: a connected roadway infrastructure device; a cloud server; and an edge server installed in a roadway device such as a roadside unit (RSU). As described, the assignment system is an element of the edge server.

In some embodiments, the assignment system includes code and routines that are operable, when executed by a processor, to cause the processor to execute one or more steps of the method 500 depicted in FIG. 5, the method 600 depicted in FIGS. 6A and 6B, the method 700 depicted in FIGS. 7A, 7B, and 7C, and the method 1000 depicted in FIG. 10. The assignment system is an element of the edge server. The edge server may be installed in a roadway device such as a roadside unit (RSU).

In some embodiments, the key manager includes code and routines that are operable, when executed by a processor, to cause the processor to execute one or more steps of the method 800 depicted in FIG. 8. The key manager is an element of the ego vehicle.

In some embodiments, the authentication system includes code and routines that are operable, when executed by a processor, to cause the processor to execute one or more steps of the method 900 depicted in FIG. 9. The authentication system is an element of the remote vehicle. Although only one remote vehicle is depicted in FIG. 1, in practice the operating environment 100 includes a plurality of remote vehicles each having similar elements as those depicted in FIG. 1. Each remote vehicle has its own instance of the authentication system.

Sometimes the description herein refers to a single remote vehicle for the purpose of clarity in writing. However, it is to be understood that a vehicular micro cloud generally includes an ego vehicle and a plurality of remote vehicles.

The ego vehicle and the remote vehicle are connected vehicles. A connected vehicle is a vehicle that includes a communication unit. An example of a communication unit includes the communication unit 145 depicted in FIG. 1. The ego vehicle 123 and the remote vehicle 124 each include their own instance of the communication unit 145. The connected roadway infrastructure device 141 also includes its own instance of the communication unit 145. In some embodiments where the edge server is not an element of the connected roadway infrastructure device 141, the edge server 198 includes its own instance of the communication unit 145.

As used herein, the term “wireless message” refers to a V2X message transmitted by a communication unit of a connected vehicle such as a remote vehicle or the ego vehicle. Terms such as “wireless message,” “V2X message,” “V2X transmission,” and “V2X communication” all refer to the same thing and can be used interchangeably.

In some embodiments, the sensor measurements described by the ego sensor data describe one or more of the following types of sensor measurements: the ego vehicle over time including its location in a roadway environment over time; the location of the ego vehicle relative to other objects within the roadway environment over time; the driver's operation of the ego vehicle over time, the presence of other objects over time within the roadway environment that includes the ego vehicle; the location of these objects in the roadway over time relative to other objects (e.g., the location of these other objects relative to one another and relative to the ego vehicle); the behavior of these other objects over time; the geometry of the roadway over time; features in the roadway over time and changes in one or more of their position, velocity, and acceleration; kinematic information about the ego vehicle and/or any objects in the roadway environment; and any aspect of the roadway environment that is measurable by the sensors included in the sensor set of the ego vehicle.

An example of the ego sensor data according to some embodiments includes the ego sensor data 195 depicted in FIG. 1. The sensors included in the sensor set, and the type of measurements they can record, are described in more detail below.

The sensor measurements recorded by an individual remote vehicle is described by remote sensor data. The remote sensor data includes digital data that describes the sensor measurements of the sensors that are included in the sensor set of the remote vehicle. In some embodiments, the individual sensor measurements are time stamped so an instance of remote sensor data describes both a sensor measurement and when this measurement was recorded. In some embodiments, the remote sensor data includes time data that describes the timestamps for the sensor measurements.

In some embodiments, the sensor measurements described by the remote sensor data describe one or more of the following: the remote vehicle over time including its location in a roadway environment over time; the location of the remote vehicle relative to other objects within the roadway environment over time; a driver's operation of the remote vehicle over time, the presence of other objects (including the presence of the ego vehicle) over time within the roadway environment that includes the remote vehicle; the location of these objects (including the location of the ego vehicle) in the roadway over time relative to other objects (e.g., the location of the ego vehicle relative to the remote vehicle as measured from the perspective of the remote vehicle); the behavior of these other objects (including the behavior of the ego vehicle) over time; the geometry of the roadway over time; features in the roadway over time and changes in one or more of their position, velocity, and acceleration; kinematic information about the remote vehicle and/or any objects in the roadway environment; and any aspect of the roadway environment that is measurable by the sensors included in the sensor set of the remote vehicle

The sensors included in the sensor sets of the remote vehicles are similar to those included in the ego vehicle.

In some embodiments, a non-transitory memory of the ego vehicle includes digital data describing object priors or other digital data that is used to identify vehicles and other objects within the roadway environment from among other objects within the roadway environment as described by the ego sensor data and/or remote sensor data.

In some embodiments, one or more of the ego vehicle 123 and the remote vehicle 124 are an autonomous vehicle or a semi-autonomous vehicle. One or more of the remote vehicles 124 may be an autonomous or semi-autonomous vehicle.

For example, the ego vehicle 123 includes a set of Advanced Driver Assistance Systems (e.g., a set of vehicle control systems) which provide autonomous features to the ego vehicle 123 which are sufficient to render the ego vehicle 123 an autonomous vehicle. The vehicle control systems include one or more ADAS systems. In some embodiments, an autonomous driving system includes a set of vehicle control systems that collectively or individually provide a set of autonomous driving features that are sufficient to render the ego vehicle a Level 3 autonomous vehicle or higher. An example of the autonomous driving system according to some embodiments includes the autonomous driving system 152 depicted in FIG. 2.

The National Highway Traffic Safety Administration (“NHTSA”) has defined different “levels” of autonomous vehicles, e.g., Level 0, Level 1, Level 2, Level 3, Level 4, and Level 5. If an autonomous vehicle has a higher-level number than another autonomous vehicle (e.g., Level 3 is a higher-level number than Levels 2 or 1), then the autonomous vehicle with a higher-level number offers a greater combination and quantity of autonomous features relative to the vehicle with the lower-level number. The different levels of autonomous vehicles are described briefly below.

Level 0: The vehicle control systems installed in a vehicle have no vehicle control. The vehicle control systems may issue warnings to the driver of the vehicle. A vehicle which is Level 0 is not an autonomous or semi-autonomous vehicle.

Level 1: The driver must be ready to take driving control of the autonomous vehicle at any time. The vehicle control systems installed in the autonomous vehicle may provide autonomous features such as one or more of the following: Adaptive Cruise Control (ACC); and Parking Assistance with automated steering and Lane Keeping Assistance (LKA) Type II, in any combination.

Level 2: The driver is obliged to detect objects and events in the roadway environment and respond if the vehicle control systems installed in the autonomous vehicle fail to respond properly (based on the driver's subjective judgement). The vehicle control systems installed in the autonomous vehicle executes accelerating, braking, and steering. The vehicle control systems installed in the autonomous vehicle can deactivate immediately upon takeover by the driver.

Level 3: Within known, limited environments (such as freeways), the driver can safely turn their attention away from driving tasks but must still be prepared to take control of the autonomous vehicle when needed.

Level 4: The vehicle control systems installed in the autonomous vehicle can control the autonomous vehicle in all but a few environments such as severe weather. The driver must enable the automated system (which is comprised of the vehicle control systems installed in the vehicle) only when it is safe to do so. When the automated system is enabled, driver attention is not required for the autonomous vehicle to operate safely and consistent with accepted norms.

Level 5: Other than setting the destination and starting the system, no human intervention is required. The automated system can drive to any location where it is legal to drive and make its own decision (which may vary based on the jurisdiction where the vehicle is located).

A highly autonomous vehicle (HAV) is an autonomous vehicle that is Level 3 or higher.

Accordingly, in some embodiments one or more of the ego vehicle 123 and/or one or more of the remote vehicles 124 are one of the following: a Level 1 autonomous vehicle; a Level 2 autonomous vehicle; a Level 3 autonomous vehicle; a Level 4 autonomous vehicle; a Level 5 autonomous vehicle; and an HAV.

In some embodiments, the vehicle control systems includes one or more of the following ADAS systems: an ACC system; an adaptive high beam system; an adaptive light control system; an automatic parking system; an automotive night vision system; a blind spot monitor; a collision avoidance system; a crosswind stabilization system; a driver drowsiness detection system; a driver monitoring system; an emergency driver assistance system; a forward collision warning system; an intersection assistance system; an intelligent speed adaption system; a lane departure warning system (also referred to as a LKA system); a pedestrian protection system; a traffic sign recognition system; a turning assistant; a wrong-way driving warning system; autopilot; sign recognition; and sign assist. Each of these example ADAS systems provide their own features and functionality that may be referred to herein as an “ADAS feature” or an “ADAS functionality,” respectively. The features and functionality provided by these example ADAS systems are also referred to herein as an “autonomous feature” or an “autonomous functionality,” respectively.

In some embodiments, system data includes some or all of the digital data described herein. An example of the system data includes the system data 129 depicted in FIG. 1.

In some embodiments, the communication unit of an ego vehicle includes a V2X radio. The V2X radio operates in compliance with a V2X protocol. In some embodiments, the V2X radio is a cellular-V2X radio (“C-V2X radio”). In some embodiments, the V2X radio broadcasts Basic Safety Messages (“BSM” or “safety message” if singular, “BSMs” or “safety messages” if plural). In some embodiments, the safety messages broadcast by the communication unit includes some or all of the system data as its payload. In some embodiments, the system data is included in part 2 of the safety message as specified by the Dedicated Short-Range Communication (DSRC) protocol. In some embodiments, the payload includes digital data that describes, among other things, sensor data that describes a roadway environment that includes the members of the vehicular micro cloud.

As used herein, the term “vehicle” refers to a connected vehicle. For example, the ego vehicle and remote vehicle depicted in FIG. 1 are connected vehicles.

A connected vehicle is a conveyance, such as an automobile, which includes a communication unit that enables the conveyance to send and receive wireless messages via one or more vehicular networks. The embodiments described herein are beneficial for both drivers of human-driven vehicles as well as the autonomous driving systems of autonomous vehicles. For example, the combined functionality of the assignment system, the key manager, and the authentication system enables the vehicles included in a vehicular micro cloud to collaborate share their unused computing resources with one another to complete computationally expensive tasks which no one vehicle could complete alone.

In some embodiments, the key manager is software installed in an onboard unit (e.g., an electronic control unit (ECU)) of an ego vehicle having V2X communication capability. The ego vehicle is a connected vehicle and operates in a roadway environment with N number of remote vehicles that are also connected vehicles, where N is any positive whole number that is sufficient to satisfy a threshold for forming a vehicular micro cloud. The roadway environment may include one or more of the following example elements: an ego vehicle; N remote vehicles; a connected roadway infrastructure device (optional); a cloud server (optional); and an edge server. The edge server may be an element of a roadside unit. For the purpose of clarity, the N remote vehicles may be referred to herein as the “remote connected vehicle” or the “remote vehicles” and this will be understood to describe N remote vehicles.

The ego vehicle and the remote vehicles may be human-driven vehicles, autonomous vehicles, or a combination of human-driven vehicles and autonomous vehicles. In some embodiments, the ego vehicle and the remote vehicles may be equipped with DSRC equipment such as a GPS unit that has lane-level accuracy and a DSRC radio that is capable of transmitting DSRC messages. In some embodiments, the V2X messages described herein are transmitted via Wi-Fi messages as described below with reference to the network 105. In some embodiments, the V2X messages are transmitted using any combination of the wireless communication protocols described herein. Accordingly, DSRC is not a required wireless communication protocol for the embodiments described herein.

### Hub or Hub Vehicle

Vehicular micro clouds are managed by a hub or hub vehicle. In some embodiments, the key manager that executes any method described herein is an element of a hub or a hub vehicle. For example, the vehicular micro cloud formed by the key manager includes a hub vehicle that provides the following example functionality in addition to the functionality of the methods described herein: (1) controlling when the set of member vehicles leave the vehicular micro cloud (i.e., managing the membership of the vehicular micro cloud, such as who can join, when they can join, when they can leave, etc.); (2) determining how to use the pool of vehicular computing resources to complete a set of tasks in an order for the set of member vehicles wherein the order is determined based on a set of factors that includes safety; (3) determining how to use the pool of vehicular computing resources to complete a set of tasks that do not include any tasks that benefit the hub vehicle; and determining when no more tasks need to be completed, or when no other member vehicles are present except for the hub vehicle, and taking steps to dissolve the vehicular micro cloud responsive to such determinations.

The “hub vehicle” may be referred to herein as the “hub.” An example of a hub vehicle according to some embodiments includes the ego vehicle 123 depicted in FIG. 1.

In some embodiments, the hub vehicle includes a memory that stores technical data. The technical data includes digital data describing the technological capabilities of each vehicle included in the vehicular micro cloud. This technical data is exchanged during a handshake process triggered by the hub vehicle to form the vehicular micro cloud. The hub vehicle also has access to each vehicle's sensor data because these vehicles broadcast V2X messages that include the sensor data as the payload for the V2X messages. An example of such V2X messages include Basic Safety Messages (BSMs) which include such sensor data in part 2 of their payload. In some embodiments, the technical data is included in the member data (and/or sensor data) depicted in FIG. 1 which vehicles such as the ego vehicle 123 and the remote vehicle 124 broadcast to one another via BSMs. In some embodiments, the member data also includes the sensor data of the vehicle that transmits the BSM as well as some or all of the other digital data described herein as being an element of the member data.

In some embodiments, the technical data is an element of the sensor data (e.g., the ego sensor data or the remote sensor data) which is included in the vehicular micro cloud data.

A vehicle's sensor data is the digital data recorded by that vehicle's onboard sensor set 126. In some embodiments, an ego vehicle's sensor data includes the sensor data recorded by another vehicle's sensor set 126; in these embodiments, the other vehicle transmits the sensor data to the ego vehicle via a V2X communication such as a BSM or some other V2X communication.

In some embodiments, the technical data is an element of the sensor data. In some embodiments, the vehicles distribute their sensor data by transmitting BSMs that includes the sensor data in its payload and this sensor data includes the technical data for each vehicle that transmits a BSM; in this way, the hub vehicle receives the technical data for each of the vehicles included in the vehicular micro cloud.

In some embodiments, the assignment system includes code and routines that, when executed by a processor, cause the processor to control when a member of the vehicular micro cloud may leave or exit the vehicular micro cloud.

In some embodiments, the assignment system includes code and routines that, when executed by a processor, cause the processor to designate a particular vehicle to serve as a member of the vehicular micro cloud responsive to determining that the particular vehicle has sufficient unused computing resources and/or trustworthiness to provide micro cloud services to a vehicular micro cloud using the unused computing resources of the particular vehicle. For example, candidate remote vehicles submit their technical data to the assignment system when they transmit their history data and their location data to the assignment system. The assignment system analyzes this technical data before assigning candidate remote vehicles to a vehicular micro cloud to ensure that they have sufficient unused computing resources to satisfy a threshold. This is beneficial because it guarantees that only those vehicles having something to contribute to the members of the vehicular micro cloud may join the vehicular micro cloud.

The existing solutions generally do not include vehicular micro clouds. Some groups of vehicles (e.g., cliques, platoons, etc.) might appear to be a vehicular micro cloud when they in fact are not a vehicular micro cloud. For example, a vehicular micro cloud requires that all its members share their unused computing resources with the other members of the vehicular micro cloud. Any group of vehicles that does not require all its members to share their unused computing resources with the other members is not a vehicular micro cloud.

In some embodiments, a vehicular micro cloud formed by a key manager is operable to harness the unused computing resources of many different vehicles to perform complex computational tasks that a single vehicle alone cannot perform (e.g., methods 500, 600, 700, 800, 900, 1000) due to the computational limitations of a vehicle's onboard vehicle computer which are known to be limited. Accordingly, any group of vehicles that does harness the unused computing resources of many different vehicles to perform complex computational tasks that a single vehicle alone cannot perform is not a vehicular micro cloud.

In some embodiments, the key manager is configured so that vehicles are required to have a predetermined threshold of unused computing resources to become members of a vehicular micro cloud. Accordingly, any group of vehicles that does not require vehicles to have a predetermined threshold of unused computing resources to become members of the group is not a vehicular micro cloud in some embodiments.

In some embodiments, a hub of a vehicular micro cloud is pre-designated by a vehicle manufacturer by the inclusion of one a bit or a token in a memory of the vehicle at the time of manufacture that designates the vehicle as the hub of all vehicular micro clouds which it joins. Accordingly, if a group of vehicles does not include a hub vehicle having a bit or a token in their memory from the time of manufacture that designates it as the hub for all groups of vehicles that it joins, then this group is not a vehicular micro cloud in some embodiments.

A vehicular micro cloud is not a V2X network or a V2V network. For example, neither a V2X network nor a V2V network include a cluster of vehicles in a same geographic region that are computationally joined to one another as members of a logically associated group of vehicles that make their unused computing resources available to the other members of the group. In some embodiments, any of the steps of a method described herein (e.g., method 700) is executed by one or more vehicles which are working together collaboratively using V2X communications for the purpose of completing one or more steps of the method(s). By comparison, solutions which only include V2X networks or V2V networks do not necessarily include the ability of two or more vehicles to work together collaboratively to complete one or more steps of a method.

In some embodiments, a vehicular micro cloud is operable to complete computational tasks itself, without delegation of these computational tasks to a cloud server, using the onboard vehicle computers of its members; this is an example of a vehicular micro cloud task according to some embodiments. In some embodiments, a group of vehicles which relies on a cloud server for its computational analysis, or the difficult parts of its computational analysis, is not a vehicular micro cloud.

### Cellular Vehicle to Everything (C-V2X)

C-V2X is an optional feature of the embodiments described herein. Some of the embodiments described herein utilize C-V2X communications. Some of the embodiments described herein do not utilize C-V2X communications. For example, the embodiments described herein utilize V2X communications other than C-V2X communications. C-V2X is defined as 3GPP direct communication (PC5) technologies that include LTE-V2X, 5G NR-V2X, and future 3GPP direct communication technologies.

Dedicated Short-Range Communication (DSRC) is now introduced. A DSRC-equipped device is any processor-based computing device that includes a DSRC transmitter and a DSRC receiver. For example, if a vehicle includes a DSRC transmitter and a DSRC receiver, then the vehicle may be described as “DSRC-enabled” or “DSRC-equipped.” Other types of devices may be DSRC-enabled. For example, one or more of the following devices may be DSRC-equipped: an edge server; a cloud server; a roadside unit (“RSU”); a traffic signal; a traffic light; a vehicle; a smartphone; a smartwatch; a laptop; a tablet computer; a personal computer; and a wearable device.

In some embodiments, instances of the term “DSRC” as used herein may be replaced by the term “C-V2X.” For example, the term “DSRC radio” is replaced by the term “C-V2X radio,” the term “DSRC message” is replaced by the term “C-V2X message,” and so on.

In some embodiments, instances of the term “V2X” as used herein may be replaced by the term “C-V2X.”

In some embodiments, one or more of the connected vehicles described above are DSRC-equipped vehicles. A DSRC-equipped vehicle is a vehicle that includes a standard-compliant GPS unit and a DSRC radio which is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages on a band that is reserved for DSRC messages.

A DSRC message is a wireless message that is specially configured to be sent and received by highly mobile devices such as vehicles, and is compliant with one or more of the following DSRC standards, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); and EN 13372:2004 Dedicated Short-Range Communication (DSRC)—DSRC profiles for RTTT applications (review); EN ISO 14906:2004 Electronic Fee Collection—Application interface.

A DSRC message is not any of the following: a WiFi message; a 3G message; a 4G message; an LTE message; a millimeter wave communication message; a Bluetooth message; a satellite communication; and a short-range radio message transmitted or broadcast by a key fob at 315 MHz or 433.92 MHz. For example, in the United States, key fobs for remote keyless systems include a short-range radio transmitter which operates at 315 MHz, and transmissions or broadcasts from this short-range radio transmitter are not DSRC messages since, for example, such transmissions or broadcasts do not comply with any DSRC standard, are not transmitted by a DSRC transmitter of a DSRC radio and are not transmitted at 5.9 GHz. In another example, in Europe and Asia, key fobs for remote keyless systems include a short-range radio transmitter which operates at 433.92 MHz, and transmissions or broadcasts from this short-range radio transmitter are not DSRC messages for similar reasons as those described above for remote keyless systems in the United States.

In some embodiments, a DSRC-equipped device (e.g., a DSRC-equipped vehicle) does not include a conventional global positioning system unit (“GPS unit”), and instead includes a standard-compliant GPS unit. A conventional GPS unit provides positional information that describes a position of the conventional GPS unit with an accuracy of plus or minus 10 meters of the actual position of the conventional GPS unit. By comparison, a standard-compliant GPS unit provides location data that describes a position of the standard-compliant GPS unit with an accuracy of plus or minus 1.5 meters of the actual position of the standard-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in even when the roadway has more than one lanes of travel each heading in a same direction.

In some embodiments, a standard-compliant GPS unit is operable to identify, monitor and track its two-dimensional position within 1.5 meters, in all directions, of its actual position 68% of the time under an open sky.

Location data includes digital data describing the location information outputted by the GPS unit. An example of the location data according to some embodiments includes the location data 151 depicted in FIG. 1.

In some embodiments, the connected vehicle described herein, and depicted in FIG. 1, includes a V2X radio instead of a DSRC radio. In these embodiments, all instances of the term DSRC” as used in this description may be replaced by the term “V2X.” For example, the term “DSRC radio” is replaced by the term “V2X radio,” the term “DSRC message” is replaced by the term “V2X message,” and so on.

75 MHz of the 5.9 GHz band may be designated for DSRC. However, in some embodiments, the lower 45 MHz of the 5.9 GHz band (specifically, 5.85-5.895 GHz) is reserved by a jurisdiction (e.g., the United States) for unlicensed use (i.e., non-DSRC and non-vehicular related use) whereas the upper 30 MHz of the 5.9 GHz band (specifically, 5.895-5.925 GHz) is reserved by the jurisdiction for Cellular Vehicle to Everything (C-V2X) use. In these embodiments, the V2X radio depicted in FIG. 1 is a C-V2X radio which is operable to send and receive C-V2X wireless messages on the upper 30 MHz of the 5.9 GHz band (i.e., 5.895-5.925 GHz). In these embodiments, the key manager 199 is operable to cooperate with the C-V2X radio and provide its functionality using the content of the C-V2X wireless messages.

In some of these embodiments, some or all of the digital data depicted in FIG. 1 is the payload for one or more C-V2X messages. In some embodiments, the C-V2X message is a BSM.

### Vehicular Network

In some embodiments, one or more of the assignment system 197, the key manager 199, and the authentication system 196 utilizes a vehicular network. A vehicular network includes, for example, one or more of the following: V2V; V2X; vehicle-to-network-to-vehicle (V2N2V); vehicle-to-infrastructure (V2I); C-V2X; any derivative or combination of the networks listed herein; and etc.

An example operating environment for the embodiments described herein includes an ego vehicle, one or more remote vehicles, and an edge server. The ego vehicle and the remote vehicle are connected vehicles having communication units that enable them to send and receive wireless messages via one or more vehicular networks.

### Example Operative Environment

Referring now to FIG. 1, depicted is a block diagram illustrating an operating environment 100 for an assignment system 197 according to some embodiments. The operating environment 100 is present in a roadway environment 140. In some embodiments, each of the elements of the operating environment 100 is present in the same roadway environment 140 at the same time. In some embodiments, some of the elements of the operating environment 100 are not present in the same roadway environment 140 at the same time.

The roadway environment 140 includes objects. Examples of objects include one or of the following: other automobiles, road surfaces; signs, traffic signals, roadway paint, medians, turns, intersections, animals, pedestrians, debris, potholes, accumulated water, accumulated mud, gravel, roadway construction, cones, bus stops, poles, entrance ramps, exit ramps, breakdown lanes, merging lanes, other lanes, railroad tracks, railroad crossings, and any other tangible object that is present in a roadway environment 140 or otherwise observable or measurable by a camera or some other sensor included in the sensor set.

The operating environment 100 may include one or more of the following elements: an ego vehicle 123 (referred to herein as a “vehicle 123” or an “ego vehicle 123”) (which has a driver 109 in embodiments where the ego vehicle 123 is not at least a Level 3 autonomous vehicle); a remote vehicle 124 (which has a driver similar to the driver 109 in embodiments where the remote vehicle 124 is not at least a Level 3 autonomous vehicle); a connected roadway infrastructure device 141; a cloud server 103; and an edge server 198. These elements are communicatively coupled to one another via a network 105. These elements of the operating environment 100 are depicted by way of illustration. In practice, the operating environment 100 may include one or more of the elements depicted in FIG. 1. For example, although only two vehicles 123, 124 are depicted in FIG. 1, in practice the operating environment 100 can include a plurality of one or more of these elements. For example, the operating environment 100 includes a plurality of remote vehicles 124 that are part of a vehicular micro cloud 194 for which the ego vehicle 123 is the hub and the vehicular access point.

The ego vehicle 123 and the remote vehicle 124 are elements (e.g., members) of a vehicular micro cloud 194. In some embodiments, the vehicular micro cloud 194 includes a plurality of remote vehicles 124. These remote vehicles 124 may be different from one another. In some embodiments, the ego vehicle 123 and the remote vehicle 124 are required to have a common manufacturer.

In some embodiments, the edge server 198 is an element of the connected roadway infrastructure device 141. In some embodiments, the operating environment 100 does not include the connected roadway infrastructure device 141 and the edge server 198 is a standalone hardware device. Elements such as the connected roadway infrastructure device 141 are depicted in FIG. 1 with a dashed line to indicate that they are optional features within the embodiments described herein. For example, the cloud server 103 is depicted with a dashed line in FIG. 1 to indicate that it is an optional feature of the embodiments described herein.

In some embodiments, the ego vehicle 123, the remote vehicle 124, the edge server 198 and the connected roadway infrastructure device 141 include similar elements. For example, each of these elements of the operating environment 100 include their own processor 125, bus 121, memory 127, communication unit 145, processor 125, sensor set 126, and onboard unit 139 (but not the edge server 198 or the connected roadway infrastructure device 141). These elements of the ego vehicle 123, the remote vehicle 124, the edge server 198 and the connected roadway infrastructure device 141 provide the same or similar functionality regardless of whether they are included in the ego vehicle 123, the remote vehicle 124, the edge server 198 or the connected roadway infrastructure device 141. Accordingly, the descriptions of these elements will not be repeated in this description for each of the ego vehicle 123, the remote vehicle 124, the edge server 198 and the connected roadway infrastructure device 141.

In the depicted embodiment, the ego vehicle 123, the remote vehicle 124, the edge server 198, and the connected roadway infrastructure device 141 store similar digital data. The system data 129 includes digital data that describes some or all of the digital data stored in the memory 127 or otherwise described herein.

In some embodiments, one or more of the vehicular micro clouds 194 are a mobile vehicular micro cloud. For example, the ego vehicle 123 and the remote vehicle 124 are vehicular micro cloud members because they are connected endpoints that are members of the vehicular micro cloud 194 that can access and use the unused computing resources (e.g., their unused processing power, unused data storage, unused sensor capabilities, unused bandwidth, etc.) of the other vehicular micro cloud members using wireless communications that are transmitted via the network 105 and these wireless communications are not required to be relayed through a cloud server or any other endpoint that is not a member of the vehicular micro cloud. As used herein, the terms a “vehicular micro cloud” and a “micro-vehicular cloud” mean the same thing.

In some embodiments, a vehicular micro cloud 194 is not a V2X network or a V2V network because, for example, such networks do not require endpoints of such networks to access and use the unused computing resources of the other endpoints of such networks. By comparison, a vehicular micro cloud 194 requires allowing all members of the vehicular micro cloud 194 to access and use designated unused computing resources of the other members of the vehicular micro cloud 194. In some embodiments, endpoints must satisfy a threshold of unused computing resources in order to join the vehicular micro cloud 194. In some embodiments, the assignment system 197 executes a process to: (1) determine whether endpoints satisfy the threshold as a condition for joining the vehicular micro cloud 194; and (2) determine whether the endpoints that do join the vehicular micro cloud 194 continue to satisfy the threshold after they join as a condition for continuing to be members of the vehicular micro cloud 194.

In some embodiments, the remote vehicles 124 complete a process to join the vehicular micro cloud 194 (e.g., a handshake process with the ego vehicle 123 acting as the hub of the vehicular micro cloud 194). The cloud server 103 and the edge server 198 are excluded from membership in the vehicular micro cloud 194.

In some embodiments, the memory 127 of one or more of the endpoints stores member data 171. The member data 171 is digital data that describes one or more of the following: the identity of each of the members; what digital data, or bits of data, are stored by each member; what computing services are available from each member; what computing resources are available from each member and what quantity of these resources are available; and how to communicate with each member (e.g., what protocol to use and which wireless band to transmit on).

In some embodiments, the member data 171 describes logical associations between endpoints which are a necessary component of the vehicular micro cloud 194 and serves to differentiate the vehicular micro cloud 194 from a mere V2X network. In some embodiments, a vehicular micro cloud 194 must include a hub vehicle and this is a further differentiation from a vehicular micro cloud 194 and a V2X network or a group, clique, or platoon of vehicles which is not a vehicular micro cloud 194.

In some embodiments, the vehicular micro cloud 194 does not include a hardware server. Accordingly, in some embodiments the vehicular micro cloud 194 may be described as serverless.

The network 105 is a conventional type, wired or wireless, and may have numerous different configurations including a star configuration, token ring configuration, or other configurations. Furthermore, the network 105 may include a local area network (LAN), a wide area network (WAN) (e.g., the Internet), or other interconnected data paths across which multiple devices and/or entities may communicate. In some embodiments, the network 105 may include a peer-to-peer network. The network 105 may also be coupled to or may include portions of a telecommunications network for sending data in a variety of different communication protocols. In some embodiments, the network 105 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, WiFi (infrastructure mode), WiFi (ad-hoc mode), visible light communication, TV white space communication and satellite communication. The network 105 may also include a mobile data network that may include 3G, 4G, 5G, millimeter wave (mmWave), LTE, LTE-V2X, LTE-D2D, VoLTE, gRPC (Remote Procedure Calls), MQTT (Message Queue Telemetry Transport) or any other mobile data network or combination of mobile data networks. Further, the network 105 may include one or more IEEE 802.11 wireless networks.

In some embodiments, the network 105 is a V2X network. For example, the network 105 must include a vehicle, such as the ego vehicle 123, as an originating endpoint for each wireless communication transmitted by the network 105. An originating endpoint is the endpoint that initiated a wireless communication using the network 105. In some embodiments, the network 105 is a vehicular network. In some embodiments, the network 105 is a C-V2X network.

In some embodiments, the network 105 is an element of the vehicular micro cloud 194. Accordingly, the vehicular micro cloud 194 is not the same thing as the network 105 since the network is merely a component of the vehicular micro cloud 194. For example, the network 105 does not include member data. The network 105 also does not include a hub vehicle.

In some embodiments, one or more of the ego vehicle 123 and the remote vehicle 124 are C-V2X equipped vehicles. For example, the ego vehicle 123 includes a standard-compliant GPS unit that is an element of the sensor set 126 and a C-V2X radio that is an element of the communication unit 145. The network 105 may include a C-V2X communication channel shared among the ego vehicle 123 and a second vehicle such as the remote vehicle 124.

A C-V2X radio is a hardware radio that includes a C-V2X receiver and a C-V2X transmitter. The C-V2X radio is operable to wirelessly send and receive C-V2X messages on a band that is reserved for C-V2X messages.

The ego vehicle 123 includes a car, a truck, a sports utility vehicle, a bus, a taxi, a semi-truck, a drone, a van, a garbage collection truck, a recycling collection truck, a train, a streetcar, a shuttle, or some other conveyance having a fixed schedule as described by the schedule data 154. For example, the ego vehicle 123 includes a garbage collection truck having a fixed schedule. In some embodiments, the ego vehicle 123 is operated by a governmental agency since the operators of these vehicles are trustworthy to handle protected information such as the selected key data 157. In some embodiments, the ego vehicle 123 is a police cruiser that travels a predetermined route according to a fixed schedule (e.g., their patrol route).

In some embodiments, the ego vehicle 123 includes an autonomous vehicle or a semi-autonomous vehicle. Although not depicted in FIG. 1, in some embodiments, the ego vehicle 123 includes an autonomous driving system. The autonomous driving system includes code and routines that provides sufficient autonomous driving features to the ego vehicle 123 to render the ego vehicle 123 an autonomous vehicle or a highly autonomous vehicle. In some embodiments, the ego vehicle 123 is a Level III autonomous vehicle or higher as defined by the National Highway Traffic Safety Administration and the Society of Automotive Engineers. In some embodiments, the vehicle control system 153 is an autonomous driving system.

The ego vehicle 123 is a connected vehicle. For example, the ego vehicle 123 is communicatively coupled to the network 105 and operable to send and receive messages via the network 105. For example, the ego vehicle 123 transmits and receives V2X messages via the network 105.

In some embodiments, the ego vehicle 123 is operable to be placed in “drone mode” which enables the ego vehicle 123 to be operated by a remote device such as the cloud server 103 or the edge server 198 in order to travel a fixed schedule described by the schedule data 154. When in drone mode the driving interface of the ego vehicle 123 is disengaged so that any input to the driving interface is not operable to control the operation of the ego vehicle 123. Instead, the operation of the ego vehicle 123 is controlled remotely by the remote device which is itself operated by one or more of a human, software, and a combination of a human and software. In this way, the ego vehicle 123 is operable to be driven by a remote source, i.e., the remote device.

For example, a remote device (e.g., the connected roadway infrastructure device 141, the edge server 198, the cloud server 103, etc.) provides wireless messages that include commands that are operable to control the operation of the ego vehicle 123 via the network 105. The communication unit 145 receives the wireless messages via the network 105. The key manager 199 of the ego vehicle 123 parses out the commands from the wireless messages and transmits them to the vehicle control system 153 of the ego vehicle 123. The vehicle control system 153 then controls the operation of the ego vehicle 123 consistent with these commands so that the schedule described by the schedule data 154 is kept. This process is repeated as more wireless messages including authenticated commands are received via the network 105.

The ego vehicle 123 includes one or more of the following elements: a processor 125; a sensor set 126; a vehicle control system 153; a communication unit 145; an onboard unit 139; a memory 127; and a key manager 199. These elements may be communicatively coupled to one another via a bus 121. In some embodiments, the communication unit 145 includes a V2X radio.

The processor 125 includes an arithmetic logic unit, a microprocessor, a general-purpose controller, or some other processor array to perform computations and provide electronic display signals to a display device. The processor 125 processes data signals and may include various computing architectures including a complex instruction set computer (CISC) architecture, a reduced instruction set computer (RISC) architecture, or an architecture implementing a combination of instruction sets. Although FIG. 1 depicts a single processor 125 present in the ego vehicle 123, multiple processors may be included in the ego vehicle 123. The processor 125 may include a graphical processing unit. Other processors, operating systems, sensors, displays, and physical configurations may be possible.

In some embodiments, the processor 125 is an element of a processor-based computing device of the ego vehicle 123. For example, the ego vehicle 123 may include one or more of the following processor-based computing devices and the processor 125 may be an element of one of these devices: an onboard vehicle computer; an electronic control unit; a navigation system; a vehicle control system (e.g., an ADAS system or autonomous driving system); and a head unit. In some embodiments, the processor 125 is an element of the onboard unit 139.

The onboard unit 139 is a special purpose processor-based computing device. In some embodiments, the onboard unit 139 is a communication device that includes one or more of the following elements: the communication unit 145; the processor 125; the memory 127; and the key manager 199. In some embodiments, the onboard unit 139 is the computer system 200 depicted in FIG. 2. In some embodiments, the onboard unit 139 is an electronic control unit (ECU).

The sensor set 126 includes one or more onboard sensors. The sensor set 126 records sensor measurements that describe the ego vehicle 123 and/or the physical environment (e.g., the roadway environment 140) that includes the ego vehicle 123. The ego sensor data 195 includes digital data that describes the sensor measurements.

In some embodiments, the sensor set 126 may include one or more sensors that are operable to measure the physical environment outside of the ego vehicle 123. For example, the sensor set 126 may include cameras, lidar, radar, sonar and other sensors that record one or more physical characteristics of the physical environment that is proximate to the ego vehicle 123.

In some embodiments, the sensor set 126 may include one or more sensors that are operable to measure the physical environment inside a cabin of the ego vehicle 123. For example, the sensor set 126 may record an eye gaze of the driver (e.g., using an internal camera), where the driver's hands are located (e.g., using an internal camera) and whether the driver is touching a head unit or infotainment system with their hands (e.g., using a feedback loop from the head unit or infotainment system that indicates whether the buttons, knobs or screen of these devices is being engaged by the driver).

In some embodiments, the sensor set 126 may include one or more of the following sensors: an altimeter; a gyroscope; a proximity sensor; a microphone; a microphone array; an accelerometer; a camera (internal or external); a LIDAR sensor; a laser altimeter; a navigation sensor (e.g., a global positioning system sensor of the standard-compliant GPS unit); an infrared detector; a motion detector; a thermostat; a sound detector, a carbon monoxide sensor; a carbon dioxide sensor; an oxygen sensor; a mass air flow sensor; an engine coolant temperature sensor; a throttle position sensor; a crank shaft position sensor; an automobile engine sensor; a valve timer; an air-fuel ratio meter; a blind spot meter; a curb feeler; a defect detector; a Hall effect sensor, a manifold absolute pressure sensor; a parking sensor; a radar gun; a speedometer; a speed sensor; a tire-pressure monitoring sensor; a torque sensor; a transmission fluid temperature sensor; a turbine speed sensor (TSS); a variable reluctance sensor; a vehicle speed sensor (VSS); a water sensor; a wheel speed sensor; and any other type of automotive sensor.

The sensor set 126 is operable to record ego sensor data 195. The ego sensor data 195 includes digital data that describes images or other measurements of the physical environment such as the conditions, objects, and other vehicles present in the roadway environment. Examples of objects include pedestrians, animals, traffic signs, traffic lights, potholes, etc. Examples of conditions include weather conditions, road surface conditions, shadows, leaf cover on the road surface, any other condition that is measurable by a sensor included in the sensor set 126.

The physical environment may include a roadway region, parking lot, or parking garage that is proximate to the ego vehicle 123. In some embodiments, the roadway environment 140 includes a roadway that includes a roadway region. The ego sensor data 195 may describe measurable aspects of the physical environment.

In some embodiments, the physical environment is the roadway environment 140. As such, in some embodiments, the roadway environment 140 includes one or more of the following: a roadway region that is proximate to the ego vehicle 123; a parking lot that is proximate to the ego vehicle 123; a parking garage that is proximate to the ego vehicle 123; the conditions present in the physical environment proximate to the ego vehicle 123; the objects present in the physical environment proximate to the ego vehicle 123; and other vehicles present in the physical environment proximate to the ego vehicle 123; any other tangible object that is present in the real-world and proximate to the ego vehicle 123 or otherwise measurable by the sensors of the sensor set 126 or whose presence is determinable from the digital data stored on the memory 127. An item is “proximate to the ego vehicle 123” if it is directly measurable by a sensor of the ego vehicle 123 or its presence is inferable and/or determinable by the key manager 199 based on analysis of the ego sensor data 195 which is recorded by the ego vehicle 123 and/or one or more members of the vehicular micro cloud 194.

In some embodiments, the ego sensor data 195 includes digital data that describes all of the sensor measurements recorded by the sensor set 126 of the ego vehicle.

For example, the ego sensor data 195 includes, among other things, one or more of the following: lidar data (i.e., depth information) recorded by an ego vehicle; or camera data (i.e., image information) recorded by the ego vehicle. The lidar data includes digital data that describes depth information about a roadway environment 140 recorded by a lidar sensor of a sensor set 126 included in the ego vehicle 123. The camera data includes digital data that describes the images recorded by a camera of the sensor set 126 included in the ego vehicle 123. The depth information and the images describe the roadway environment 140, including tangible objects in the roadway environment 140 and any other physical aspects of the roadway environment 140 that are measurable using a depth sensor and/or a camera.

In some embodiments, the sensors of the sensor set 126 are operable to collect ego sensor data 195. The sensors of the sensor set 126 include any sensors that are necessary to measure and record the measurements described by the ego sensor data 195. In some embodiments, the ego sensor data 195 includes any sensor measurements that are necessary to generate the other digital data stored by the memory 127. In some embodiments, the ego sensor data 195 includes digital data that describes any sensor measurements that are necessary for the key manager 199 and/or the assignment system 197 to provide their functionality as described herein with reference to the method 500 depicted in FIG. 4, the method 600 depicted in FIGS. 6A and 6B, the method 700 depicted in FIGS. 7A, 7B, and 7C, the method 800 depicted in FIGS. 8A and 8B, the method 900 depicted in FIG. 9, and the method 1000 depicted in FIG. 10.

In some embodiments, the sensor set 126 includes any sensors that are necessary to record ego sensor data 195 that describes the roadway environment 140 in sufficient detail to create a digital twin of the roadway environment 140.

Digital twin data 162 includes any digital data, software, and/or other information that is necessary to execute one or more digital twin simulations.

Digital twins, and an example process for generating and using digital twins which is implemented by the assignment system 197 in some embodiments, are described in U.S. patent application Ser. No. 16/521,574 entitled “Altering a Vehicle based on Driving Pattern Comparison” filed on Jul. 24, 2019, the entirety of which is hereby incorporated by reference.

The ego sensor data 195 includes digital data that describes any measurement that is taken by one or more of the sensors of the sensor set 126.

The standard-compliant GPS unit includes a GPS unit that is compliant with one or more standards that govern the transmission of V2X wireless communications (“V2X communication” if singular, “V2X communications” if plural). For example, some V2X standards require that BSMs are transmitted at intervals by vehicles and that these BSMs must include within their payload location data having one or more attributes. In some embodiments, the standard-compliant GPS unit is an element of the sensor set 126.

An example of an attribute for location data 151 is accuracy. In some embodiments, the standard-compliant GPS unit is operable to generate GPS measurements which are sufficiently accurate to describe the location of the ego vehicle 123 with lane-level accuracy. Lane-level accuracy is necessary to comply with some of the existing and emerging standards for V2X communication (e.g., C-V2X communication). Lane-level accuracy means that the GPS measurements are sufficiently accurate to describe which lane of a roadway that the ego vehicle 123 is traveling (e.g., the geographic position described by the GPS measurement is accurate to within 1.5 meters of the actual position of the ego vehicle 123 in the real-world). Lane-level accuracy is described in more detail below.

In some embodiments, the standard-compliant GPS unit is compliant with one or more standards governing V2X communications but does not provide GPS measurements that are lane-level accurate.

In some embodiments, the standard-compliant GPS unit includes any hardware and software necessary to make the ego vehicle 123 or the standard-compliant GPS unit compliant with one or more of the following standards governing V2X communications, including any derivative or fork thereof: EN 12253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); and EN 13372:2004 Dedicated Short-Range Communication (DSRC)—DSRC profiles for RTTT applications (review); EN ISO 14906:2004 Electronic Fee Collection—Application interface.

In some embodiments, the standard-compliant GPS unit is operable to provide location data 151 describing the location of the ego vehicle 123 with lane-level accuracy. For example, the ego vehicle 123 is traveling in a lane of a multi-lane roadway. Lane-level accuracy means that the lane of the ego vehicle 123 is described by the location data 151 so accurately that a precise lane of travel of the ego vehicle 123 may be accurately determined based on the location data 151 for this ego vehicle 123 as provided by the standard-compliant GPS unit.

An example process for generating location data 151 describing a geographic location of an object (e.g., a vehicle, a roadway object, an object of interest, a remote vehicle 124, the ego vehicle 123, or some other tangible object or construct located in a roadway environment 140) is now described according to some embodiments. In some embodiments, the key manager 199 of the ego vehicle 123 (or the authentication system 196 of the remote vehicle 124) include code and routines that are operable, when executed by the processor 125, to cause the processor to: analyze (1) location data 151 describing the geographic location of the ego vehicle 123 and (2) ego sensor data 195 describing the range separating the ego vehicle 123 from an object and a heading for this range; and determine, based on this analysis, location data 151 describing the location of the object. The location data 151 describing the location of the object may also have lane-level accuracy because, for example, it is generated using accurate location data 151 of the ego vehicle 123 and accurate sensor data describing information about the object.

In some embodiments, the standard-compliant GPS unit includes hardware that wirelessly communicates with a GPS satellite (or GPS server) to retrieve location data 151 that describes the geographic location of the ego vehicle 123 with a precision that is compliant with a V2X standard. One example of a V2X standard is the DSRC standard. Other standards governing V2X communications are possible. The DSRC standard requires that location data 151 be precise enough to infer if two vehicles (one of which is, for example, the ego vehicle 123) are located in adjacent lanes of travel on a roadway. In some embodiments, the standard-compliant GPS unit is operable to identify, monitor and track its two-dimensional position within 1.5 meters of its actual position 68% of the time under an open sky. Since roadway lanes are typically no less than 3 meters wide, whenever the two-dimensional error of the location data 151 is less than 1.5 meters the key manager 199 of the ego vehicle 123 (or the authentication system 196 of the remote vehicle 124) described herein may analyze the location data 151 provided by the standard-compliant GPS unit and determine what lane the ego vehicle 123 is traveling in based on the relative positions of two or more different vehicles (one of which is, for example, the ego vehicle 123) traveling on a roadway at the same time.

By comparison to the standard-compliant GPS unit, a conventional GPS unit which is not compliant with the DSRC standard is unable to determine the location of a vehicle (e.g., the ego vehicle 123) with lane-level accuracy. For example, a typical roadway lane is approximately three meters wide. However, a conventional GPS unit only has an accuracy of plus or minus 10 meters relative to the actual location of the ego vehicle 123. As a result, such conventional GPS units are not sufficiently accurate to enable the key manager 199 of the ego vehicle 123 (or the authentication system 196 of the remote vehicle 124) to determine the lane of travel of the ego vehicle 123. This measurement improves the accuracy of the location data 151 because it describes the location of lanes used by the ego vehicle 123.

In some embodiments, the standard-compliant GPS unit enables the GPS system to calculate more accurate routes as described by the schedule data 154.

In some embodiments, the memory 127 stores two types of location data 151. The first is location data 151 of the ego vehicle 123 and the second is Location data of one or more objects (e.g., the remote vehicle 124 or some other object in the roadway environment). The location data 151 of the ego vehicle 123 is digital data that describes a geographic location of the ego vehicle 123. The location data 151 of the objects is digital data that describes a geographic location of an object. One or more of these two types of location data 151 may have lane-level accuracy.

In some embodiments, one or more of these two types of location data 151 are described by the ego sensor data 195. For example, the standard-compliant GPS unit is a sensor included in the sensor set 126 and the location data 151 is an example type of ego sensor data 195.

In some embodiments, the key manager 199 of the ego vehicle 123 (or the authentication system 196 of the remote vehicle 124) causes an electronic display of the ego vehicle 123 to display a message describing information relating to the functionality provided by the key manager 199. For example, the key manager 199 of the ego vehicle 123 (or the authentication system 196 of the remote vehicle 124) causes an electronic display of the ego vehicle 123 to display a message describing an outcome of an authentication service. The message is displayed as an element of a graphical user interface (GUI). GUI data 187 includes digital data that describes the GUI that includes the message. The key manager 199 of the ego vehicle 123 (or the authentication system 196 of the remote vehicle 124) generates and outputs the GUI described by the GUI data 187.

In some embodiments, the GUI is displayed on an electronic display (not depicted) of the ego vehicle 123. In some embodiments, the key manager 199 of the ego vehicle 123 (or the authentication system 196 of the remote vehicle 124) is communicatively coupled to the electronic display to provide the GUI data 187 to the electronic display and control the operation of the electronic display to display the GUI. In some embodiments, the electronic display is a touchscreen that is also operated to receive inputs from the occupant of the ego vehicle 123 (e.g., acknowledgement of the authentication result, a request the resubmit the authentication request, etc.).

The communication unit 145 transmits and receives data to and from a network 105 or to another communication channel. In some embodiments, the communication unit 145 may include a DSRC transmitter, a DSRC receiver and other hardware or software necessary to make the ego vehicle 123 a DSRC-equipped device. In some embodiments, the key manager 199 of the ego vehicle (and the assignment system 197 of the remote vehicle) is operable to control all or some of the operation of the communication unit 145.

In some embodiments, the communication unit 145 includes a port for direct physical connection to the network 105 or to another communication channel. For example, the communication unit 145 includes a USB, SD, CAT-5, or similar port for wired communication with the network 105. In some embodiments, the communication unit 145 includes a wireless transceiver for exchanging data with the network 105 or other communication channels using one or more wireless communication methods, including: IEEE 802.11; IEEE 802.16, BLUETOOTH®; EN ISO 14906:2004 Electronic Fee Collection—Application interface EN 11253:2004 Dedicated Short-Range Communication—Physical layer using microwave at 5.8 GHz (review); EN 12795:2002 Dedicated Short-Range Communication (DSRC)—DSRC Data link layer: Medium Access and Logical Link Control (review); EN 12834:2002 Dedicated Short-Range Communication—Application layer (review); EN 13372:2004 Dedicated Short-Range Communication (DSRC)—DSRC profiles for RTTT applications (review); the communication method described in U.S. patent application Ser. No. 14/471,387 filed on Aug. 28, 2014 and entitled “Full-Duplex Coordination System”; or another suitable wireless communication method.

In some embodiments, the communication unit 145 includes a radio that is operable to transmit and receive V2X messages via the network 105. For example, the communication unit 145 includes a radio that is operable to transmit and receive any type of V2X communication described above for the network 105.

In some embodiments, the communication unit 145 includes a full-duplex coordination system as described in U.S. Pat. No. 9,369,262 filed on Aug. 28, 2014 and entitled “Full-Duplex Coordination System,” the entirety of which is incorporated herein by reference. In some embodiments, some, or all of the communications necessary to execute the methods described herein are executed using full-duplex wireless communication as described in U.S. Pat. No. 9,369,262.

In some embodiments, the communication unit 145 includes a cellular communications transceiver for sending and receiving data over a cellular communications network including via short messaging service (SMS), multimedia messaging service (MMS), hypertext transfer protocol (HTTP), direct data connection, WAP, e-mail, or another suitable type of electronic communication. In some embodiments, the communication unit 145 includes a wired port and a wireless transceiver. The communication unit 145 also provides other conventional connections to the network 105 for distribution of files or media objects using standard network protocols including TCP/IP, HTTP, HTTPS, and SMTP, millimeter wave, DSRC, etc.

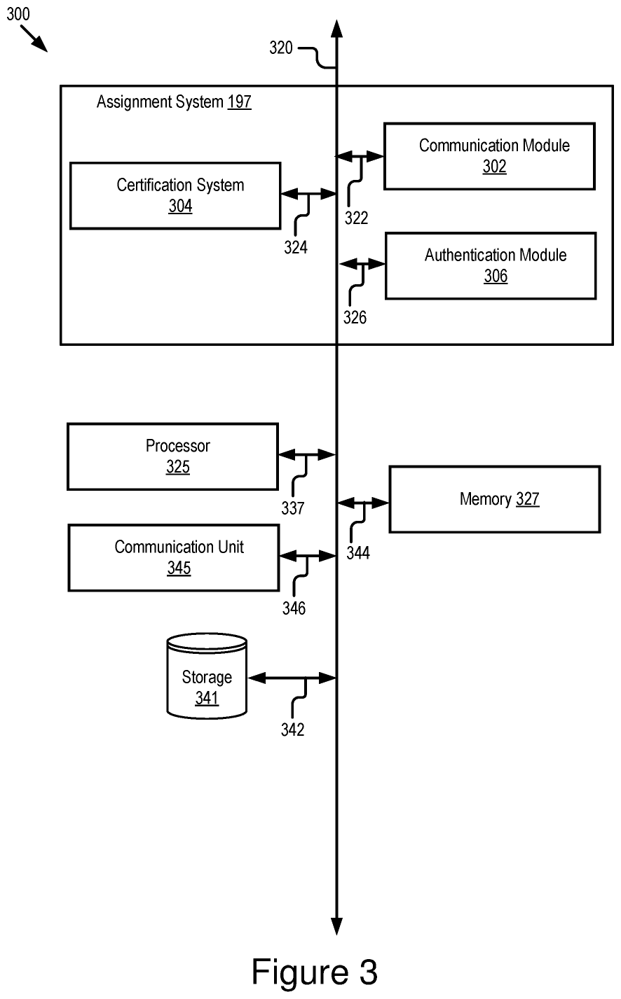

In some embodiments, the communication unit 145 includes a V2X radio. The V2X radio is a hardware unit that includes one or more transmitters and one or more receivers that is operable to send and receive any type of V2X message. In some embodiments, the V2X radio is a C-V2X radio that is operable to send and receive C-V2X messages. In some embodiments, the C-V2X radio is operable to send and receive C-V2X messages on the upper 30 MHz of the 5.9 GHz band (i.e., 5.895-5.925 GHz). In some embodiments, some or all of the wireless messages described above with reference to the method 300 depicted in FIG. 3 are transmitted by the C-V2X radio on the upper 30 MHz of the 5.9 GHz band (i.e., 5.895-5.925 GHz) as directed by the key manager 199 and/or the authentication system 196.

In some embodiments, the V2X radio includes a DSRC transmitter and a DSRC receiver. The DSRC transmitter is operable to transmit and broadcast DSRC messages over the 5.9 GHz band. The DSRC receiver is operable to receive DSRC messages over the 5.9 GHz band. In some embodiments, the DSRC transmitter and the DSRC receiver operate on some other band which is reserved exclusively for DSRC.

In some embodiments, the V2X radio includes a non-transitory memory which stores digital data that controls the frequency for broadcasting BSMs or CPMs. In some embodiments, the non-transitory memory stores a buffered version of the Location data for the ego vehicle 123 so that the Location data for the ego vehicle 123 is broadcast as an element of the BSMs or CPMs which are regularly broadcast by the V2X radio (e.g., at an interval of once every 0.10 seconds).

In some embodiments, the V2X radio includes any hardware or software which is necessary to make the ego vehicle 123 compliant with the DSRC standards or any other wireless communication standard that applies to wireless vehicular communications. In some embodiments, the standard-compliant GPS unit (not pictured) is an element of the V2X radio.

The memory 127 may include a non-transitory storage medium. The memory 127 may store instructions or data that may be executed by the processor 125. The instructions or data may include code for performing the techniques described herein. The memory 127 may be a dynamic random-access memory (DRAM) device, a static random-access memory (SRAM) device, flash memory, or some other memory device. In some embodiments, the memory 127 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In some embodiments, the memory 127 may store any or all of the digital data or information described herein.

As depicted in FIG. 1, the memory 127 stores the following digital data: the threshold data 163; the member data 171; the digital twin data 162; the vehicular micro cloud data 133; the location data 151; the analysis data 181; the GUI data 187; the remote sensor data; the ego sensor data 195; the history data 183; the heading data 173; the security data 193; the requirements data 192; the selected key data 157; the certification data 159; and the schedule data 154. The system data 129 includes some or all of this digital data for some or all of the endpoints included in the vehicular micro cloud 194. In some embodiments, the V2X messages (or C-V2X messages or the set of wireless messages) described herein are also stored in the memory 127. The above-described elements of the memory 127 were described above, and so, those descriptions will not be repeated here.

The security data 193 includes digital data that describes security profile from an ego vehicle (or a candidate to become an ego vehicle). The security data 193 may be included in a request to become certified to become an ego vehicle 123. For example, the key manager 199 includes code and routines that are operable, when executed by the processor 125, to cause the processor 125 to build a request by a vehicle submitted to the assignment system. The request includes a request to become an ego vehicle. For example, the ego vehicle 123 is a candidate ego vehicle at a time t₁ and the key manager 199 for the candidate ego vehicle builds and sends a request to become certified to become an ego vehicle 123 for a vehicular micro cloud 194 which is not yet formed at time t₁. Responsive to this request, the assignment system 197 may determine to certify the candidate vehicle to operate as an ego vehicle 123 (i.e., the hub and vehicular access point) for a vehicular micro cloud 194 at a time t2 that occurs after time t₁. See, e.g., the method 700 depicted in FIGS. 7A, 7B, and 7C. The request includes a V2X message including, for example, the security data 193.

In some embodiments, the request to be certified to as an ego vehicle 123 is included in a submission that includes the security data 193 for the ego vehicle 123, the location data 151 for the ego vehicle 123, the schedule data 154 for the ego vehicle 123, and the heading data 173 for the ego vehicle 123. For example, the submission described in step 605 of method 600 depicted in FIGS. 6A and 6B is modified to include security data 193 so that the assignment system 197 can certify the candidate ego vehicle to operate as an ego vehicle 123 as well as determine whether to assign the candidate ego vehicle to become the ego vehicle 123 for a particular vehicular micro cloud 194. In some embodiments, the request to be certified as an ego vehicle 123 is sent separate from the submission described in step 605 of the method 600 depicted in FIGS. 6A and 6B.

In some embodiments, the security data 193 includes digital data describing one or more of the following which are included in the security profile for the ego vehicle 123: one or more operating systems installed in one or more onboard vehicle computers of the ego vehicle 123; version information for the operating systems; a description of all security patches installed therein; a description of when the software for these onboard vehicle computers was last updated; a description of the kernels for these onboard vehicle computers; a security log describing all authorized and unauthorized interactions with these onboard vehicle computers or their wireless transmissions; a description of the firmware installed in one or more communication units of the ego vehicle 123; a description of the security patches installed in the communication units; a description of the when the firmware for these communication units was last updated; a security log describing all authorized and unauthorized interactions with these communication units or their wireless transmissions; a description of the latency for each of the wireless transmissions transmitted by these communications units (as described by latency data); a description of the encryption capabilities of the communication unit 145 and/or the onboard vehicle computers of the ego vehicle 123; a description of the outcome of the historical wireless transmissions transmitted by the ego vehicle (e.g., time-out error, successful transmission, indicia of malevolent action, etc.); a description of past certifications to operate as an ego vehicle 123 that have been received; and a date when these past certifications were issued.

In some embodiments, the requirements data 192 includes digital data that describes the minimum requirements for a candidate ego vehicle to be certified as an ego vehicle or for a currently certified ego vehicle to be recertified to continue operating as an ego vehicle after a latency period has elapsed.

For example, the requirements data 192 describes the minimum requirements for one or more of the following: the operating system version, operating system software patches, operating systems update date; an acceptable time delta from the operating system update being made available and the operating system update being installed (e.g., because the delta indicates a length of vulnerability to known attack); acceptable operating system kernels; types and/or quantities of unauthorized interactions with the operations of the onboard vehicle computer which are unacceptable or indicate a compromised or malicious endpoint (e.g., signatures obtainable by analysis of the security log indicating the ego vehicle is compromised or operated by a malicious party); the communication unit 145 firmware version, firmware software patches, firmware update date; an acceptable time delta from the firmware update being made available and the firmware update being installed; acceptable firmware kernels; types and/or quantities of unauthorized interactions with the operations of the communication unit which are unacceptable or indicate a compromised or malicious endpoint; mean latency threshold (e.g., 0.01 seconds or less); and a number of past unsuccessful or timed-out communications; an amount of time that a certification is valid; and an expiration requirement for any past issued certifications regardless of any validity period included in the certification (e.g., requirement new certification regardless of the validity period, e.g., due to present increased security concern).

The certification data 159 includes digital data describing a certification for a vehicle to operate an ego vehicle 123. For example, the certification certifies a candidate ego vehicle to operate as an ego vehicle 123 or recertifies an existing ego vehicle 123 to continue operating as an ego vehicle 123. In some embodiments, the certification includes a certification for a vehicle to operate as an ego vehicle 123 for a predetermined period of time (e.g., 1 day, 10 days, 30 days, etc.). The predetermined period of time is the validity period for the certification. The certification may not be honored for the full validity period. For example, at a later date, if there is a security threat (e.g., a national emergency, known or suspected activity by a malicious entity, discovery of a security threat, etc.) then this validity period may not be honored by the assignment system 197 and the ego vehicle 123 is required to repeat the process for receiving the certification to ensure that the ego vehicle 123 is not compromised or operated or otherwise controlled by a malicious entity.

Global key data 167 includes digital data describing all authentication keys for every remote vehicle 124 that is enrolled with the assignment system 197. A remote vehicle 124 is enrolled with the assignment system 197 by registering its authentication information with the assignment system via a registration process. The authentication information includes a unique identifier (e.g., VIN) for a particular remote vehicle 124 and key information for the remote vehicle 124. For example, the remote vehicle 124 stores a first key on its own memory 127 and the remote vehicle provides a second key to the assignment system 197. The first key and the second key form a key pair. Other types of authentication information are possible so long as the assignment system 197 has access to sufficient information to know which authentication information corresponds to which particular remote vehicle 124 after the registration process for each remote vehicle 124 is completed.

In some embodiments, the global key data 167 is indexed based on the unique vehicle identifiers for each registered remote vehicle 124 (one that is registered with the authentication system 197). For example, the global key data 167 is organized as a data set and the key information for each remote vehicle 124 registered with the assignment system 197 is indexed using the unique vehicle identifier submitted with the key information during the enrollment process for each remote vehicle 124 so that the key information for that particular remote vehicle 124 is retrievable from the global key data 167 by querying the global key data 167 using the unique vehicle identifier for that particular remote vehicle 124.

The selected key data 157 includes a subset of the global key data 167. When a candidate ego vehicle is assigned to become an ego vehicle 123 for a group of remote vehicles 124 then the assignment system 197 provides the ego vehicle 123 with the key information for the group of remote vehicles 124 that are assigned to that ego vehicle 123 so that the ego vehicle 123 can authenticate these remote vehicles 124. Providing only the subset of key information instead of the entire global key data 167 is beneficial because it limits the number of copies of the key information stored at different endpoints thereby reducing the possibility that this information will be stolen or copied by an uncertified entity or malicious entity.

With reference to method 600 depicted in FIGS. 6A and 6B, the submissions from step 605 of FIG. 6A include unique vehicle identifiers and, using this information, the assignment system 197 queries the global key data 167 to retrieve the selected key data 157. The selected key data 157 includes the authentication information (e.g., authentication keys) for only the remote vehicles 124 that are selected to be part of the group of remote vehicles 124 managed by the ego vehicle 123. Accordingly, the selected key data 157 includes a set of selected authentication keys for the remote vehicles 124 assigned to be part of the group of remote vehicles 124 managed by the ego vehicle 123 (e.g., those remote vehicles 124 that will be part of the vehicular micro cloud 194 for which the ego vehicle 123 is assigned to be the hub and vehicular access point).

Some or all of the system data 129 can be organized in a data structure that is stored in the memory 127 in some embodiments.

In some embodiments, the ego vehicle 123 includes a vehicle control system 153. A vehicle control system 153 includes one or more ADAS systems or an autonomous driving system.

Examples of an ADAS system include one or more of the following elements of a vehicle: an adaptive cruise control (“ACC”) system; an adaptive high beam system; an adaptive light control system; an automatic parking system; an automotive night vision system; a blind spot monitor; a collision avoidance system; a crosswind stabilization system; a driver drowsiness management system; a driver monitoring system; an emergency driver assistance system; a forward collision warning system; an intersection assistance system; an intelligent speed adaption system; a lane keep assistance (“LKA”) system; a pedestrian protection system; a traffic sign recognition system; a turning assistant; and a wrong-way driving warning system. Other types of ADAS systems are possible. This list is illustrative and not exclusive.

An ADAS system is an onboard system that is operable to identify one or more factors (e.g., using one or more onboard vehicle sensors) affecting the ego vehicle 123 and modify (or control) the operation of its host vehicle (e.g., the ego vehicle 123) to respond to these identified factors. Described generally, ADAS system functionality includes the process of (1) identifying one or more factors affecting the ego vehicle and (2) modifying the operation of the ego vehicle, or some component of the ego vehicle, based on these identified factors.

For example, an ACC system installed and operational in an ego vehicle may identify that a subject vehicle being followed by the ego vehicle with the cruise control system engaged has increased or decreased its speed. The ACC system may modify the speed of the ego vehicle based on the change in speed of the subject vehicle, and the detection of this change in speed and the modification of the speed of the ego vehicle is an example the ADAS system functionality of the ADAS system.

Similarly, an ego vehicle 123 may have a LKA system installed and operational in an ego vehicle 123 may detect, using one or more external cameras of the ego vehicle 123, an event in which the ego vehicle 123 is near passing a center yellow line which indicates a division of one lane of travel from another lane of travel on a roadway. The LKA system may provide a notification to a driver of the ego vehicle 123 that this event has occurred (e.g., an audible noise or graphical display) or take action to prevent the ego vehicle 123 from actually passing the center yellow line such as making the steering wheel difficult to turn in a direction that would move the ego vehicle over the center yellow line or actually moving the steering wheel so that the ego vehicle 123 is further away from the center yellow line but still safely positioned in its lane of travel. The process of identifying the event and acting responsive to this event is an example of the ADAS system functionality provided by the LKA system.

The other ADAS systems described above each provide their own examples of ADAS system functionalities which are known in the art, and so, these examples of ADAS system functionality will not be repeated here.

In some embodiments, the ADAS system includes any software or hardware included in the vehicle that makes that vehicle qualify as an autonomous vehicle or a semi-autonomous vehicle. In some embodiments, an autonomous driving system is a collection of ADAS systems which provides sufficient ADAS functionality to the ego vehicle 123 to render the ego vehicle 123 an autonomous or semi-autonomous vehicle. An example of the autonomous driving system according to some embodiments includes the autonomous driving system 152 depicted in FIG. 2.

An autonomous driving system includes a set of ADAS systems whose operation render sufficient autonomous functionality to render the ego vehicle 123 an autonomous vehicle (e.g., a Level III autonomous vehicle or higher as defined by the National Highway Traffic Safety Administration and the Society of Automotive Engineers).

In some embodiments, the key manager 199 includes code and routines that are operable, when executed by the processor 125, to cause the processor 125 to execute one or more steps of method 800 depicted in FIG. 8. An example embodiment of the key manager 199 is depicted in FIG. 2. This embodiment is described in more detail below.

In some embodiments, the key manager 199 is an element of the onboard unit 139 or some other onboard vehicle computer. In some embodiments, the key manager 199 includes code and routines that are stored in the memory 127 and executed by the processor 125 or the onboard unit 139. In some embodiments, the key manager 199 is an element of an onboard unit of the ego vehicle 123 which executes the key manager 199 and controls the operation of the communication unit 145 of the ego vehicle 123 based at least in part on the output from executing the key manager 199.

In some embodiments, the key manager 199 is implemented using hardware including a field-programmable gate array (“FPGA”) or an application-specific integrated circuit (“ASIC”). In some other embodiments, the key manager 199 is implemented using a combination of hardware and software.

The remote vehicle 124 includes elements and functionality which are similar to those described above for the ego vehicle 123, and so, those descriptions will not be repeated here. The remote vehicle 124 does not include an instance of the key manager 199. The ego vehicle 123 does not include an authentication system 196. The ego vehicle 123 and one or more remote vehicles 124 are members of a vehicular micro cloud 194 in which the ego vehicle 123 is the hub and vehicular access point.

The memory 127 of the remote vehicle 124 stores some or all of the system data 129.

The remote vehicle 124 includes an authentication system 196. In some embodiments, the authentication system 196 includes code and routines that are operable, when executed by the processor 125 of the remote vehicle 124, to cause the processor 125 to execute one or more steps of method 900 depicted in FIG. 9. An example embodiment of the authentication system 196 is depicted in FIG. 4. This embodiment is described in more detail below.

In some embodiments, the authentication system 196 is an element of the onboard unit 139 of the remote vehicle 124 or some other onboard vehicle computer. In some embodiments, the authentication system 196 includes code and routines that are stored in the memory 127 of the remote vehicle 124 and executed by the processor 125 or the onboard unit 139 of the remote vehicle 124. In some embodiments, the authentication system 196 is an element of an onboard unit of the authentication system 196 which executes the authentication system 196 and controls the operation of the communication unit 145 of the remote vehicle 124 based at least in part on the output from executing the authentication system 196.

In some embodiments, the authentication system 196 is implemented using hardware including an FPGA or an ASIC. In some other embodiments, the authentication system 196 is implemented using a combination of hardware and software.

The connected roadway infrastructure device 141 includes elements and functionality which are similar to those described above for the ego vehicle 123, and so, those descriptions will not be repeated here.

In some embodiments, the connected roadway infrastructure device 141 includes hardware that enables the connected roadway infrastructure device 141 to modify the flow of traffic in the roadway. For example, the connected roadway infrastructure device 141 is operable to control the operation of a traffic signal, the information depicted on a sign, modify the direction of travel in a lane of traffic; open or close lanes; meter traffic into a roadway; modify the flow of traffic through an intersection; modify the speed of traffic, etc. In some embodiments, the connected roadway infrastructure device 141 includes a roadside unit that includes the hardware that provides the functionality described herein. In some embodiments, the connected roadway infrastructure device 141 includes a roadside unit having a processor and a communication unit that enables the roadside unit to send and receive wireless messages via the network 105 and execute one or more of the steps described herein.

In some embodiments, the connected roadway infrastructure device 141 includes a non-transitory memory (not pictured) that stores digital data such as the system data 129.

The roadway environment 140 is now described according to some embodiments. In some embodiments, one or more of the ego vehicle 123, the remote vehicle 124 (or a plurality of remote vehicles), and the connected roadway infrastructure device 141 are located in a roadway environment 140. In some embodiments, the roadway environment 140 includes a vehicular micro cloud 194. The roadway environment 140 is a portion of the real-world that includes a roadway, the ego vehicle 123 and the remote vehicle 124. The roadway environment 140 may include other elements such as roadway signs, environmental conditions, traffic, etc. The roadway environment 140 includes some or all of the tangible and/or measurable qualities described above with reference to the ego sensor data 195 and the remote sensor data. The remote sensor data includes digital data that describes the sensor measurements recorded by the sensor set(s) 126 of the remote vehicle(s) 124.

In some embodiments, the real-world includes the reality of human experience comprising physical objects and excludes artificial environments and “virtual” worlds such as computer simulations.

The roadway environment 140 includes an edge server 198. The edge server 198 is a connected processor-based computing device that includes an instance of the assignment system 197 and the other elements described above with reference to the ego vehicle 123 (e.g., a processor 125, a memory 127 storing some or all of the system data 129, a communication unit 145, etc.). In some embodiments, the roadway device is a member of the vehicular micro cloud 194.

In some embodiments, the edge server 198 includes one or more of the following elements: a hardware server; a personal computer; a laptop; a device such as a roadside unit; or any other processor-based connected device that includes an instance of the assignment system 197 and a non-transitory memory that stores some or all of the digital data that is stored by the memory 127 of the ego vehicle 123 or otherwise described herein. For example, the memory 127 stores the system data 129. The system data 129 includes some or all of the digital data depicted in FIG. 1 as being stored by the memory 127.

In some embodiments, the edge server 198 includes a backbone network. The edge server 198 includes the following: an instance of the assignment system 197; and a non-transitory memory storing system data 129, the global key data 167, and the selected key data 157. The edge server 198 also includes instances of each of the following: the processor 125; and the communication unit 145. The functionality of these elements was described above with reference to the ego vehicle 123, and so, those descriptions will not be repeated here.

In some embodiments, the assignment system 197 includes code and routines that are operable, when executed by the processor 125 of the edge server 198, to cause the processor 125 to execute one or more steps of method 500 depicted in FIG. 5, the method 600 depicted in FIGS. 6A and 6B, the method 700 depicted in FIGS. 7A, 7B, and 7C, and the method 1000 depicted in FIG. 10. An example embodiment of the assignment system 197 is depicted in FIG. 3. This embodiment is described in more detail below.

In some embodiments the assignment system 197 includes simulation software. The simulation software is any simulation software that is capable of simulating the operation of a candidate ego vehicle and one or more remote vehicles to determine similarities in their headings, schedules, and locations as described herein. In this way the simulation software is operable to output a result describing which ego vehicle and which remote vehicles should be assigned to form a vehicular micro cloud as described herein.

A digital twin is a simulated version of a specific real-world vehicle that exists in a simulation. A structure, condition, behavior, and responses of the digital twin are similar to a structure, condition, behavior, and responses of the specific real-world vehicle that the digital twin represents in the simulation. The digital environment included in the simulation is similar to the real-world roadway environment 140 of the real-world vehicle. The simulation software includes code and routines that are operable to execute simulations based on digital twins of real-world vehicles in the roadway environment.

In some embodiments, the simulation software is integrated with the assignment system 197. In some other embodiments, the simulation software is a standalone software that the assignment system 197 can access to execute digital twin simulations.

In some embodiments, the assignment system 197 is implemented using hardware including an FPGA or an ASIC. In some other embodiments, the assignment system 197 is implemented using a combination of hardware and software.

In some embodiments, the cloud server 103 includes one or more of the following: a hardware server; a personal computer; a laptop; a device such as a roadside unit; or any other processor-based connected device that is not a member of the vehicular micro cloud 194 and includes a non-transitory memory that stores some or all of the system data 129 or otherwise described herein.

In some embodiments, the cloud server 103 includes one or more of the following elements: an instance of the assignment system 197; and a non-transitory memory storing system data 129. In some embodiments, the memory of the cloud server 103 stores the global key data 167. The functionality of these elements was described above with reference to the ego vehicle 123, and so, those descriptions will not be repeated here.

In some embodiments, the wireless messages described herein are encrypted themselves or transmitted via an encrypted communication provided by the network 105. In some embodiments, the network 105 may include an encrypted virtual private network tunnel (“VPN tunnel”) that does not include any infrastructure components such as network towers, hardware servers or server farms. In some embodiments, the key manager 199, the assignment system 197, and the authentication system 196 include encryption keys for encrypting wireless messages and decrypting the wireless messages described herein.

Referring now to FIG. 2, depicted is a block diagram illustrating an example computer system 200 including a key manager 199 according to some embodiments.

In some embodiments, the computer system 200 may include a special-purpose computer system that is programmed to perform one or more steps of the method 800 described herein with reference to FIG. 8.

In some embodiments, the computer system 200 may include a processor-based computing device. For example, the computer system 200 may include an onboard vehicle computer system of one or more of the ego vehicle 123 and the remote vehicle 124.

The computer system 200 may include one or more of the following elements according to some examples: the key manager 199; a processor 125; a communication unit 145; a vehicle control system 153; a storage 241; an autonomous driving system 152; and a memory 127. The components of the computer system 200 are communicatively coupled by a bus 220.

In some embodiments, the computer system 200 includes additional elements such as those depicted in FIG. 1 as elements of the key manager 199.

In the illustrated embodiment, the processor 125 is communicatively coupled to the bus 220 via a signal line 237. The communication unit 145 is communicatively coupled to the bus 220 via a signal line 246. The vehicle control system 153 is communicatively coupled to the bus 220 via a signal line 247. The storage 241 is communicatively coupled to the bus 220 via a signal line 242. The memory 127 is communicatively coupled to the bus 220 via a signal line 244. The sensor set 126 is communicatively coupled to the bus 220 via a signal line 248. The autonomous driving system 152 is communicatively coupled to the bus 220 via a signal line 243.

In some embodiments, the sensor set 126 includes standard-compliant GPS unit. In some embodiments, the communication unit 145 includes a network sniffer.

The following elements of the computer system 200 were described above with reference to FIG. 1, and so, these descriptions will not be repeated here: the processor 125; the communication unit 145; the vehicle control system 153; the memory 127; the sensor set 126; and the autonomous driving system 152.

The storage 241 can be a non-transitory storage medium that stores data for providing the functionality described herein. The storage 241 may be a DRAM device, a SRAM device, flash memory, or some other memory devices. In some embodiments, the storage 241 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In some embodiments, the key manager 199 includes code and routines that are operable, when executed by the processor 125, to cause the processor 125 to execute one or more steps of the method 800 described herein with reference to FIG. 8.

In the illustrated embodiment shown in FIG. 2, the key manager 199 includes a communication module 202 and an authentication module 206. The communication module 202 is communicatively coupled to the bus 220 via a signal line 222. The authentication module 206 is communicatively coupled to the bus 220 via a signal line 226.

The communication module 202 can be software including routines for handling communications between the key manager 199 and other components of the computer system 200. In some embodiments, the communication module 202 can be a set of instructions executable by the processor 125 to provide the functionality described below for handling communications between the key manager 199 and other components of the computer system 200. In some embodiments, the communication module 202 can be stored in the memory 127 of the computer system 200 and can be accessible and executable by the processor 125. The communication module 202 may be adapted for cooperation and communication with the processor 125 and other components of the computer system 200 via a signal line 222.

The communication module 202 sends and receives data, via the communication unit 145, to and from one or more elements of the operating environment 100.

In some embodiments, the communication module 202 receives data from components of the key manager 199 and stores the data in one or more of the storage 241 and the memory 127.

In some embodiments, the communication module 202 may handle communications between components of the key manager 199 or the computer system 200.

The authentication module 206 can be software including routines for providing the authentication service for the members of a vehicular micro cloud in cooperation with one or more other authentication modules operable on other endpoints. For example, the authentication module 206 of the key manager 199 of an ego vehicle 123 cooperates with one or more of the following entities to provide the authentication service: the authentication module 306 of the assignment system 197 of an edge server 198; and one or more authentication modules 406 of one or more remote vehicles 124 that are members of the vehicular micro cloud 194 being managed by the ego vehicle 123 which stores the key manager 199.

In some embodiments, the authentication module 206 can be a set of instructions executable by the processor 125 to provide the functionality described below for authenticating members of the vehicular micro cloud. In some embodiments, the authentication module 206 can be stored in the memory 127 of the computer system 200 and can be accessible and executable by the processor 125. The authentication module 206 may be adapted for cooperation and communication with the processor 125 and other components of the computer system 200 via a signal line 226.

The authentication module 206 causes the communication module 202 to sends and receives data, via the communication unit 145, to and from one or more elements of the operating environment 100 in order to provide the authentication service.

In some embodiments, the authentication module 206 receives data from components of the key manager 199 and causes the communication module 202 to store the data in one or more of the storage 241 and the memory 127.

Referring now to FIG. 3, depicted is a block diagram illustrating an example computer system 300 including an assignment system 197 according to some embodiments.

In some embodiments, the computer system 300 may include a special-purpose computer system that is programmed to perform one or more steps of the method 500 described herein with reference to FIG. 5, method 600 described herein with reference to FIGS. 6A and 6B, method 700 described herein with reference to FIGS. 7A, 7B, and 7C, and method 1000 described herein with reference to FIG. 10.

In some embodiments, the computer system 300 may include a processor-based computing device.

The computer system 300 may include one or more of the following elements according to some examples: the assignment system 197; a processor 325; a communication unit 345; a storage 341; and a memory 327. The components of the computer system 300 are communicatively coupled by a bus 320.

The processor 325 includes functionality similar to that described above for the processor 125 of FIG. 1, and so, those descriptions will not be repeated here. The communication unit 345 includes functionality similar to that described above for the communication unit 145 of FIG. 1, and so, those descriptions will not be repeated here. The storage 341 includes functionality similar to that described above for the storage 241 of FIG. 2, and so, those descriptions will not be repeated here. The memory 327 includes functionality similar to that described above for the memory 127 of FIG. 1, and so, those descriptions will not be repeated here.

In some embodiments, the computer system 300 includes additional elements such as those depicted in FIG. 1.

In the illustrated embodiment, the processor 325 is communicatively coupled to the bus 320 via a signal line 337. The communication unit 345 is communicatively coupled to the bus 320 via a signal line 346. The storage 341 is communicatively coupled to the bus 320 via a signal line 342. The memory 327 is communicatively coupled to the bus 320 via a signal line 344.

In the depicted embodiment the assignment system 197 includes a communication module 302, a certification system 304, and an authentication module 306. The communication module 306 is communicatively coupled to the bus 320 via a signal line 322. The certification system 304 is communicatively coupled to the bus 320 via a signal line 324. The authentication module 306 is communicatively coupled to the bus 320 via a signal line 326.

The communication module 302 provides the same functionality as the communication module 202 described above with reference to FIG. 2, and so, those descriptions will not be repeated here.

The authentication module 306 provides the same functionality as the authentication module 206 described above with reference to FIG. 2, and so, those descriptions will not be repeated here.

The certification system 304 is communicatively coupled to the bus 320 via a signal line 324. In some embodiments, the certification system includes code and routines that are operable, when executed by the processor 325, to cause the processor 325 to execute one or more steps of the method 700 described herein with reference to FIGS. 7A, 7B, and 7C.

In some embodiments, the assignment system 197 includes code and routines that are operable, when executed by the processor 325, to cause the processor 325 to execute one or more steps of the method 500 described herein with reference to FIG. 5. In some embodiments, the assignment system 197 includes code and routines that are operable, when executed by the processor 325, to cause the processor 325 to execute one or more steps of the method 600 described herein with reference to FIGS. 6A and 6B. In some embodiments, the assignment system 197 includes code and routines that are operable, when executed by the processor 325, to cause the processor 325 to execute one or more steps of the method 700 described herein with reference to FIGS. 7A, 7B, and 7C. In some embodiments, the assignment system 197 includes code and routines that are operable, when executed by the processor 325, to cause the processor 325 to execute one or more steps of the method 1000 described herein with reference to FIG. 10.

Referring now to FIG. 4, depicted is a block diagram illustrating an example computer system 400 including an authentication system 196 according to some embodiments.

In some embodiments, the computer system 400 may include a special-purpose computer system that is programmed to perform one or more steps of the method 900 described herein with reference to FIG. 9.

In some embodiments, the computer system 400 may include a processor-based computing device.

The computer system 400 may include one or more of the following elements according to some examples: the authentication system 196; a processor 425; a communication unit 445; a vehicle control system 453; an autonomous driving system 452, a storage 441; and a memory 427. The components of the computer system 400 are communicatively coupled by a bus 420.

The processor 425 includes functionality similar to that described above for the processor 125 of FIG. 1, and so, those descriptions will not be repeated here. The communication unit 445 includes functionality similar to that described above for the communication unit 145 of FIG. 1, and so, those descriptions will not be repeated here. The vehicle control system 453 includes functionality similar to that described above for the communication unit 145 of FIG. 1, and so, those descriptions will not be repeated here. The autonomous driving system 452 includes functionality similar to that described above for the autonomous driving system 152 of FIG. 1, and so, those descriptions will not be repeated here. The storage 441 includes functionality similar to that described above for the storage 241 of FIG. 2, and so, those descriptions will not be repeated here. The memory 327 includes functionality similar to that described above for the memory 127 of FIG. 1, and so, those descriptions will not be repeated here. The sensor set 426 includes functionality similar to that described above for the sensor set 126 of FIG. 1, and so, those descriptions will not be repeated here. The notification system 428 was described above with reference to FIG. 1, and so, those descriptions will not be repeated here.

In some embodiments, the computer system 400 includes additional elements such as those depicted in FIG. 1.

In the illustrated embodiment, the processor 425 is communicatively coupled to the bus 420 via a signal line 437. The communication unit 445 is communicatively coupled to the bus 420 via a signal line 446. The vehicle control system 453 is communicatively coupled to the bus 420 via a signal line 447. The autonomous driving system 452 is communicatively coupled to the bus 420 via a signal line 443. The storage 441 is communicatively coupled to the bus 420 via a signal line 442. The memory 427 is communicatively coupled to the bus 420 via a signal line 444. The sensor set 426 is communicatively coupled to the bus 420 via a signal line 448. The notification system is communicatively coupled to the bus 420 via a signal line 449.

In some embodiments, the authentication system 196 includes code and routines that are operable, when executed by the processor 425, to cause the processor 425 to execute one or more steps of the method 900 described herein with reference to FIG. 9.

In the illustrated embodiment shown in FIG. 4, the authentication system 196 includes a communication module 402 and an authentication module 406. The communication module 402 is communicatively coupled to the bus 420 via a signal line 422. The authentication module 406 is communicatively coupled to the bus 420 via a signal line 426.

The communication module 402 provides the same functionality as the communication module 202 described above with reference to FIG. 2, and so, those descriptions will not be repeated here.

The authentication module 406 provides the same functionality as the authentication module 206 described above with reference to FIG. 2, and so, those descriptions will not be repeated here.

In some embodiments, two or more of the authentication modules 206, 306, 406 cooperate together to provide the authentication service. For example, the authentication module 206 of the key manager 199 cooperates with a plurality of authentication modules 406 of a plurality of remote vehicles using V2X communications to provide the authentication service for these remote vehicles which are members of a vehicular micro cloud and the key manager is an element of an ego vehicle that is the hub of this vehicular micro cloud.

In some embodiments, the authentication modules 206, 306, 406 provide the authentication service using a Remote Authentication Dial-In User Service (RADIUS) protocol. In the RADIUS protocol, remote network users connect to their networks through a network access server (NAS). For example, the authentication module 206 includes a NAS. The NAS of the authentication module 206 of a key manager 199 queries the authentication module 306 of the authentication module 306 of the assignment system 197 to get selected key data 157 about each of the remote vehicles assigned to the vehicular micro cloud managed by the ego vehicle 123 which includes the key manager 199.

Examples of the authentication service are now described according to some embodiments. These examples are illustrative and not limiting.

In some embodiments, the selected key data stored by an ego vehicle and accessible by a key manager includes a unique vehicle identifier for each remote vehicle assigned to the ego vehicle as well as a password for each of these remote vehicles. In this embodiment, a particular remote vehicle has a copy of their password stored in their location memory as their local authentication information so that, for this particular remote vehicle, the ego vehicle and the particular remote vehicle have a copy of both the unique vehicle identifier for the particular remote vehicle and the password associated with this unique vehicle identifier. The authentication module 406 of this particular remote vehicle causes the password to be transmitted to the authentication module 206 of the ego vehicle via V2X message so that the particular remote vehicle is authenticated by the authentication module 206 of the ego vehicle. In some embodiments, the password is encrypted prior to being transmitted to the authentication module 206 via V2X communications so that the password is secured during transmission. In some embodiments, the V2X message including the password is transmitted via an encrypted VPN tunnel.

In some embodiments, the selected key data stored by an ego vehicle and accessible by a key manager includes a unique vehicle identifier for each remote vehicle assigned to the ego vehicle as well as an encrypted secret. Each remote vehicle and their assigned ego vehicle has a copy of the encrypted secret so that the encrypted secret can be referred to as an “encrypted shared secret.” In this embodiment, each remote vehicle has a copy of their secret stored in their location memory as their local authentication information so that, for each remote vehicle, the ego vehicle and the remote vehicle know both their unique vehicle identifier and the shared secret associated with this unique vehicle identifier. The authentication module 406 of the remote vehicle causes the shared secret to be transmitted to the authentication module 206 of the ego vehicle via V2X so that the particular remote vehicle is authenticated by the authentication module 206 of the ego vehicle. The shared secret is encrypted prior to being transmitted to the authentication module 206 via V2X communications so that the shared secret is secured during transmission. In some embodiments, the V2X message including the shared secret is transmitted via an encrypted VPN tunnel.

Referring now to FIG. 5, depicted is a flowchart of an example method 500 according to some embodiments. The method 500 includes step 505, step 510, step 515, and 520 as depicted in FIG. 4. The steps of the method 500 may be executed in any order, and not necessarily those depicted in FIG. 5. In some embodiments, one or more of the steps are skipped or modified in ways that are described herein or known or otherwise determinable by those having ordinary skill in the art.

Referring now to FIGS. 6A and 6B, depicted is a flowchart of an example method 600 according to some embodiments. The method 600 includes a step 605, a step 610, a step 615, and a step 620 as depicted in FIG. 6A and a step 625, a step 630, and a step 635 as depicted in FIG. 6B. The steps of the method 600 may be executed in any order, and not necessarily those depicted in FIGS. 6A and 6B. In some embodiments, one or more of the steps are skipped or modified in ways that are described herein or known or otherwise determinable by those having ordinary skill in the art.

Referring now to FIGS. 7A, 7B, and 7C, depicted is a flowchart of an example method 700 according to some embodiments. The method 700 includes a step 705 as depicted in FIG. 7A, a step 710 and a step 715 as depicted in FIG. 7B, and a step 720 and a step 725 as depicted in FIG. 7C. The steps of the method 700 may be executed in any order, and not necessarily those depicted in FIGS. 7A, 7B, and 7C. In some embodiments, one or more of the steps are skipped or modified in ways that are described herein or known or otherwise determinable by those having ordinary skill in the art.

Referring now to FIGS. 8A and 8B, depicted is a flowchart of an example method 800 according to some embodiments. The method 800 includes a step 805, a step 810, a step 815, and a step 820 as depicted in FIG. 8A and a step 825, a step 830, a step 835, and a step 840 as depicted in FIG. 8B. The steps of the method 800 may be executed in any order, and not necessarily those depicted in FIGS. 8A and 8B. In some embodiments, one or more of the steps are skipped or modified in ways that are described herein or known or otherwise determinable by those having ordinary skill in the art.

Referring now to FIG. 9, depicted is a flowchart of an example method 900 according to some embodiments. The method 900 includes a step 905, a step 910, a step 915, a step 920, and a step 925 as depicted in FIG. 9. The steps of the method 900 may be executed in any order, and not necessarily those depicted in FIG. 9. In some embodiments, one or more of the steps are skipped or modified in ways that are described herein or known or otherwise determinable by those having ordinary skill in the art.

Referring now to FIG. 10, depicted is a flowchart of an example method 1000 according to some embodiments. The method 1000 includes a step 1005, a step 1010, a step 1015, a step 1020, a step 1025, and a step 1030 as depicted in FIG. 10. The steps of the method 1000 may be executed in any order, and not necessarily those depicted in FIG. 10. In some embodiments, one or more of the steps are skipped or modified in ways that are described herein or known or otherwise determinable by those having ordinary skill in the art.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the present embodiments can be described above primarily with reference to user interfaces and particular hardware. However, the present embodiments can apply to any type of computer system that can receive data and commands, and any peripheral devices providing services.

Reference in the specification to “some embodiments” or “some instances” means that a particular feature, structure, or characteristic described in connection with the embodiments or instances can be included in at least one embodiment of the description. The appearances of the phrase “in some embodiments” in various places in the specification are not necessarily all referring to the same embodiments.

Some portions of the detailed descriptions that follow are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present embodiments of the specification can also relate to an apparatus for performing the operations herein. This apparatus may be specially constructed for the required purposes, or it may include a general-purpose computer selectively activated or reconfigured by a computer program stored in the computer. Such a computer program may be stored in a computer-readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some preferred embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

An assignment system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited, to keyboards, displays, pointing devices, etc.) can be coupled to the system either directly or through intervening I/O controllers.

Network adapters may also be coupled to the system to enable the assignment system to become coupled to other assignment systems or remote printers or storage devices through intervening private or public networks. Modems, cable modem, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the embodiments of the specification has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, or formats. Furthermore, as will be apparent to one of ordinary skill in the relevant art, the modules, routines, features, attributes, methodologies, and other aspects of the disclosure can be implemented as software, hardware, firmware, or any combination of the three. Also, wherever a component, an example of which is a module, of the specification is implemented as software, the component can be implemented as a standalone program, as part of a larger program, as a plurality of separate programs, as a statically or dynamically linked library, as a kernel-loadable module, as a device driver, or in every and any other way known now or in the future to those of ordinary skill in the art of computer programming. Additionally, the disclosure is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A method executed by a processor of an edge server, the method comprising:
determining a group of remote vehicles having a similar heading and a similar schedule as an ego vehicle;
determining that the ego vehicle is within a communication range of the group based on location data of the ego vehicle and the group;
selecting the ego vehicle to serve as a vehicular access point for a vehicular micro cloud including the ego vehicle and the group as members; and
transmitting selected authentication keys to the ego vehicle wherein the selected authentication keys correspond to the group so that the ego vehicle authenticates the group based on the selected authentication keys.

2. The method of claim 1, wherein a similar heading includes the ego vehicle and the group having headings that satisfy a threshold for similarity.

3. The method of claim 1, wherein a similar schedule includes the ego vehicle and the group having schedules that satisfy a threshold for similarity.

4. The method of claim 1, wherein selecting the ego vehicle to serve as the vehicular access point for the vehicular micro cloud is based on the similar heading shared between the ego vehicle and the group.

5. The method of claim 1, wherein selecting the ego vehicle to serve as the vehicular access point for the vehicular micro cloud is based on at least one of: the similar schedule shared between the ego vehicle and the group; the similar schedule shared between the ego vehicle and the group; and the determination that the ego vehicle is within the communication range of the group.

6. The method of claim 1, wherein selecting the ego vehicle to serve as the vehicular access point for the vehicular micro cloud is based on each of: the similar schedule shared between the ego vehicle and the group; the similar schedule shared between the ego vehicle and the group; and the determination that the ego vehicle is within the communication range of the group.

7. The method of claim 1, wherein the ego vehicle is selected from a group that includes: a bus; a taxi; a parking enforcement vehicle; a refuse collection truck; and a government inspection vehicle.

8. The method of claim 1, wherein the ego vehicle is owned and operated by a government entity.

9. The method of claim 1, wherein a latency of the ego vehicle authenticating the group satisfies a threshold for latency.

10. The method of claim 1 further comprising executing a certification process operable to ensure that the ego vehicle is trusted before transmitting the selected authentication keys to the ego vehicle.

11. The method of claim 1 further comprising determining that a particular remote vehicle from the group is no longer within the communication range of the ego vehicle, determining a new ego vehicle closest to the particular remote vehicle, and sending an authentication key for the particular remote vehicle to the new ego vehicle.

12. The method of claim 11 further comprising instructing the ego vehicle to delete the authentication key for the particular remote vehicle from the selected authentication keys stored by the ego vehicle so that only one vehicle stores the authentication key for the particular remote vehicle at any one time.

13. A system of an edge server comprising:
a non-transitory memory;
and a processor communicatively coupled to the non-transitory memory, wherein the non-transitory memory stores computer readable code that is operable, when executed by the processor, to cause the processor to execute steps including:
determining a group of remote vehicles having a similar heading and a similar schedule as an ego vehicle;
determining that the ego vehicle is within a communication range of the group based on location data of the ego vehicle and the group;
selecting the ego vehicle to serve as a vehicular access point for a vehicular micro cloud including the ego vehicle and the group as members; and
transmitting selected authentication keys to the ego vehicle wherein the selected authentication keys correspond to the group so that the ego vehicle authenticates the group based on the selected authentication keys.

14. The system of claim 13, wherein the non-transitory memory stores additional computer readable code that is operable, when executed by the processor, to cause the processor to execute additional steps including executing a certification process operable to ensure that the ego vehicle is trusted before transmitting the selected authentication keys to the ego vehicle.

15. The system of claim 13, wherein the non-transitory memory stores additional computer readable code that is operable, when executed by the processor, to cause the processor to execute additional steps including determining that a particular remote vehicle from the group is no longer within the communication range of the ego vehicle, determining a new ego vehicle closest to the particular remote vehicle, and sending an authentication key for the particular remote vehicle to the new ego vehicle.

16. The system of claim 15, wherein the non-transitory memory stores additional computer readable code that is operable, when executed by the processor, to cause the processor to execute additional steps including instructing the ego vehicle to delete the authentication key for the particular remote vehicle from the selected authentication keys stored by the ego vehicle so that only one vehicle stores the authentication key for the particular remote vehicle at any one time in addition to the edge server that also stores the authentication key for the particular remote vehicle.

17. A computer program product including computer code stored on a non-transitory memory that is operable, when executed by a processor, to cause the processor to execute operations including:
determining a group of remote vehicles having a similar heading and a similar schedule as an ego vehicle;
determining that the ego vehicle is within a communication range of the group based on location data of the ego vehicle and the group;
selecting the ego vehicle to serve as a vehicular access point for a vehicular micro cloud including the ego vehicle and the group as members; and
transmitting selected authentication keys to the ego vehicle wherein the selected authentication keys correspond to the group so that the ego vehicle authenticates the group based on the selected authentication keys.

18. The computer program product of claim 17, wherein the non-transitory memory stores additional computer readable code that is operable, when executed by the processor, to cause the processor to execute additional steps including executing a certification process operable to ensure that the ego vehicle is trusted before transmitting the selected authentication keys to the ego vehicle.

19. The computer program product of claim 17, wherein the non-transitory memory stores additional computer readable code that is operable, when executed by the processor, to cause the processor to execute additional steps including determining that a particular remote vehicle from the group is no longer within the communication range of the ego vehicle, determining a new ego vehicle closest to the particular remote vehicle, and sending an authentication key for the particular remote vehicle to the new ego vehicle.

20. The computer program product of claim 19, wherein the non-transitory memory stores additional computer readable code that is operable, when executed by the processor, to cause the processor to execute additional steps including instructing the ego vehicle to delete the authentication key for the particular remote vehicle from the selected authentication keys stored by the ego vehicle so that only one vehicle the authentication key for the particular remote vehicle at any one time.
